(19) United States
(12) Patent Application Publication
(10) Pub. No.: US 2022/0120658 A1
(43) Pub. Date: Apr. 21, 2022

(54) FLOW CYTOMETERS INCLUDING TILTED BEAM SHAPING OPTICAL COMPONENTS, AND METHODS OF USING THE SAME

(71) Applicant: Becton, Dickinson and Company, Franklin Lakes, NJ (US)

(72) Inventors: Bing Shan, San Jose, CA (US); Fedor Ilkov, Morgan Hill, CA (US); Brianna Conroy, San Jose, CA (US)

(21) Appl. No.: 17/481,705

(22) Filed: Sep. 22, 2021

Related U.S. Application Data
(60) Provisional application No. 63/094,111, filed on Oct. 20, 2020.

(51) Int. Cl. G01N 15/14

(52) U.S. Cl. CPC G01N 15/1404; G01N 2015/1452; G01N 15/1436

(57) ABSTRACT

Flow cytometers including tilted beam shaping optical components are provided. In certain embodiments, the subject flow cytometers include a flow cell, a light source configured to produce a beam for irradiating particles in the flow cell at an interrogation point, and a tilted beam shaping optical component positioned between the light source and the flow cell. In such embodiments, the tilted beam shaping optical component is configured to generate beam ellipticity by creating astigmatism in the beam. In some embodiments, the tilted beam shaping optical component is a lens. In other embodiments, the tilted beam shaping optical component is a concave mirror. Methods of analyzing a sample using a flow cytometer including a tilted beam shaping optical component are also provided.

### CROSS-REFERENCE TO RELATED APPLICATION

Pursuant to 35 U.S.C. § 119 (e), this application claims priority to the filing dates of U.S. Provisional Patent Application Ser. No. 63/094,111 filed Oct. 20, 2020, the disclosure of which application is incorporated herein by reference in their entirety.

### INTRODUCTION

Flow cytometry is a technique used to characterize and often times sort biological material, such as cells of a blood sample or particles of interest in another type of biological or chemical sample. A flow cytometer typically includes a sample reservoir for receiving a fluid sample, such as a blood sample, and a sheath reservoir containing a sheath fluid. The flow cytometer transports the particles (including cells) in the fluid sample as a cell stream to a flow cell, while also directing the sheath fluid to the flow cell. To characterize the components of the flow stream, the flow stream is irradiated with light. Variations in the materials in the flow stream, such as morphologies or the presence of fluorescent labels, may cause variations in the observed light and these variations allow for characterization and separation.

In general, flow cytometry involves the irradiation of a flow cell with a beam of light possessing an elliptical beam shape. Beam ellipticity promotes uniform laser intensity across the core flow thereby ensuring optimal irradiation of particles passing through the flow cell. Such ellipticity flattens the laser profile so that the area in which the flow cell is irradiated with peak laser intensity is broader. For example, FIG. 1 depicts a cell 104 passing through a flow cell in direction 105. Cell 104 passes through each of laser beam 101, 102 and 103 one at a time. Laser beams 101, 102 and 103 are shown to possess elliptical beam shapes.

Beam ellipticity is conventionally generated using devices such as cylindrical lens(es) or/and anamorphic prism pair(s), e.g., as described in prior patents by Luo et al. in U.S. Pat. No. 7,561,267 B2 and Blasenheim in US 2004/0061853 A1.

### SUMMARY

Conventional approaches require multiple sets of optics that prevent streamlining of the particle analyzer systems. The inventors have realized that systems and methods for generating beam ellipticity while simplifying flow cytometer design are consequently required. Embodiments of the invention satisfy this need.

Aspects of the invention include flow cytometers having tilted beam shaping optical components. The subject flow cytometers include a flow cell and a light source configured to produce a beam for irradiating particles in the flow cell at an interrogation point, as well as a tilted beam shaping optical component positioned between the light source and the flow cell. In embodiments, the tilted beam shaping optical component is configured to generate ellipticity in the beam, i.e., generate an elliptically shaped beam of light for irradiating the particles in the flow cell. In certain embodiments, the tilted beam shaping optical component is configured to produce beam ellipticity by creating astigmatism in the beam. In some embodiments, the tilted beam shaping optical component includes a lens or lens assembly. In other embodiments, the tilted beam shaping optical component includes a concave mirror. In certain embodiments, the subject flow cytometers additionally include a fiber optic bundle comprising a first fiber optic operably coupled to a first laser and configured to receive light from the first laser at a proximal end and to convey the laser light beam from a distal end to a first position on the flow stream, and a second fiber optic operably coupled to a second laser and configured to receive light from the second laser at a proximal end and to convey the laser light beam from a distal end to a second position on the flow stream. In further embodiments, the light source is configured to produce a flat-top beam and includes a square core fiber. In certain embodiments, the subject flow cytometers further include one or more detectors for measuring characteristics of particles in the flow cell that have been irradiated by an elliptical beam generated by the tilted beam shaping optical component.

Aspects of the invention also include methods of analyzing a sample that include introducing the sample into a flow cytometer having a tilted beam shaping optical component. In certain embodiments, the sample is a biological sample (e.g., a sample that includes cells). In embodiments, methods include irradiating particles in a flow cell with an elliptical beam generated by a tilted beam shaping optical component. In certain embodiments, the the tilted beam shaping optical component is configured to produce beam ellipticity by creating astigmatism in the beam. In some embodiments, the tilted beam shaping optical component includes a lens. In other embodiments, the tilted beam shaping optical component includes a concave mirror. In certain embodiments, the light source includes a fiber optic bundle comprising a first fiber optic operably coupled to a first laser and configured to receive light from the first laser at a proximal end and to convey the laser light beam from a distal end to a first position on the flow stream, and a second fiber optic operably coupled to a second laser and configured to receive light from the second laser at a proximal end and to convey the laser light beam from a distal end to a second position on the flow stream. In further embodiments, the light source is configured to produce a flat-top beam and includes a square core fiber. In certain embodiments, the methods include measuring characteristics of particles in the flow cell that have been irradiated by an elliptical beam generated by the tilted beam shaping optical component.

### BRIEF DESCRIPTION OF THE FIGURES

The invention may be best understood from the following detailed description when read in conjunction with the accompanying drawings. Included in the drawings are the following figures:

FIG. 1 depicts a flow cell.

FIG. 2A depicts a circularly shaped collimated beam focused by a straight lens.

FIG. 2B depicts a circularly shaped collimated beam focused by a tilted lens according to certain embodiments.

FIG. 3 depicts a beam outputted by a fiber optic light convey or focused by a tilted concave mirror according to certain embodiments.

FIG. 4 depicts a light source having a plurality of lasers and a light propagation component that includes operably coupled fiber optics according to certain embodiments.

FIG. 5 depicts beams outputted by a fiber optic bundle focused by a tilted concave mirror according to certain embodiments.

FIG. 6 depicts a flow cytometer according to certain embodiments.

FIG. 7 depicts a block diagram of a computing system according to certain embodiments.

FIG. 8 depicts a block diagram of a computing system according to certain embodiments.

FIG. 9 depicts a chart representing the relationship between beam size and distance from the concave mirror.

FIG. 10 depicts an experimental device including a tilted beam shaping optical component.

FIG. 11 depicts experimentally obtained results collected from an optical system that includes a tilted beam shaping optical component.

FIG. 12 depicts experimentally obtained results collected from an optical system that includes a tilted beam shaping optical component.

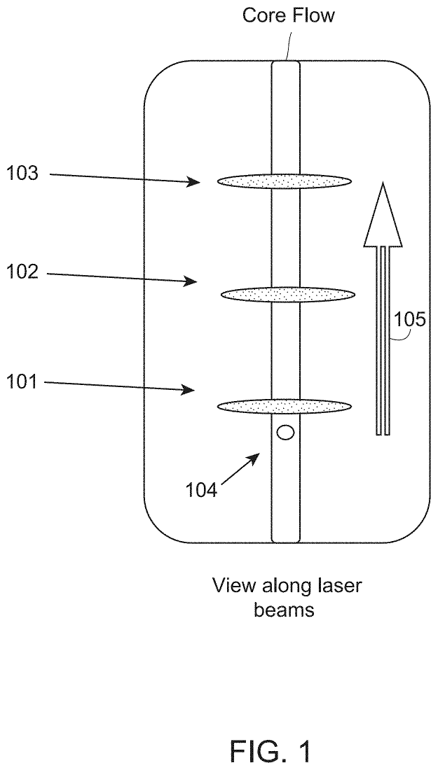

### DETAILED DESCRIPTION

Flow cytometers including tilted beam shaping optical components are provided. In certain embodiments, the subject flow cytometers include a flow cell, a light source configured to produce a beam for irradiating particles in the flow cell at an interrogation point, and a tilted beam shaping optical component positioned between the light source and the flow cell. In such embodiments, the tilted beam shaping optical component is configured to generate beam ellipticity by creating astigmatism in the beam. In some embodiments, the tilted beam shaping optical component is a lens. In other embodiments, the tilted beam shaping optical component is a concave mirror. Methods of analyzing a sample using a flow cytometer including a tilted beam shaping optical component are also provided.

Before the present invention is described in greater detail, it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

Certain ranges are presented herein with numerical values being preceded by the term “about.” The term “about” is used herein to provide literal support for the exact number that it precedes, as well as a number that is near to or approximately the number that the term precedes. In determining whether a number is near to or approximately a specifically recited number, the near or approximating unrecited number may be a number which, in the context in which it is presented, provides the substantial equivalent of the specifically recited number.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, representative illustrative methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

It is noted that, as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

While the system and method has or will be described for the sake of grammatical fluidity with functional explanations, it is to be expressly understood that the claims, unless expressly formulated under 35 U.S.C. § 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 U.S.C. § 112 are to be accorded full statutory equivalents under 35 U.S.C. § 112.

### Flow Cytometers Including Tilted Beam Shaping Optical Components

As discussed above, aspects of the invention involve flow cytometers including a light source, a flow cell, and a tilted beam shaping optical component configured to generate beam ellipticity. By “generate beam ellipticity”, it is meant alter the beam produced by the light source such that it assumes an elliptical shape. In some embodiments, where the light source is a laser, the beam ellipticity generated by the tilted beam shaping optical component flattens the laser profile so that the area in which the flow cell is irradiated with peak laser intensity is broadened thereby ensuring uniform laser intensity in the flow cell. As discussed herein, a “flow cell” is employed in its conventional sense to refer to an component, such as a cuvette, containing a liquid stream for transporting particles in a sheath fluid.

In some embodiments, the tilted beam shaping optical components described herein are configured to generate beam ellipticity by creating astigmatism in the beam. “Astigmatism” is employed in its conventional sense to describe a beam in which rays propagating in perpendicular planes possess different foci, i.e., the beam is focused at multiple points along the beam axis. In such embodiments, the subject tilted beam shaping optical component creates astigmatism based on tilt, i.e., the extent to which the tilted beam shaping optical component is slanted. In other words, in embodiments where the beam passes through the beam shaping optical component, the tilted beam shaping optical component is characterized by an imaginary axis passing through the length of the beam shaping optical component existing at an oblique angle relative to a vertical axis orthogonal to the optical axis of the beam produced by the light source. In embodiments, the tilt of the tilted beam shaping optical component is characterized by an angle of incidence, i.e., the angle between a ray of light incident on the surface of the tilted beam shaping optical component and the line perpendicular to said component at the point of incidence. In some embodiments, the tilt of the tilted beam shaping optical component ranges from 1 degree to 50 degrees, such as 1 degree to 20 degrees, and including 5 degrees to 7 degrees. In some embodiments, the tilt of the tilted beam shaping optical component may be 5 degrees, 6, degrees, 7, degrees, 8 degrees, 9 degrees and including 10 degrees. In certain embodiments, the tilt of the tilted beam shaping optical component is adjustable. In some embodiments, the tilt of the tilted beam shaping optical is manually adjustable by a user so that a desired amount of beam astigmatism is achieved. In other embodiments, the tilt of the tilted beam shaping optical component is mechanically adjustable. In such embodiments, tilt may be adjusted by a motor, such as a stepper motor, servo motor, brushless electric motor, brushed DC motor, micro-step drive motor, high resolution stepper motor, among other types of motors. In embodiments, adjusting the tilt of the tilted beam shaping optical component alters the major axis of the resulting beam.

The tilted beam shaping optical components described herein may, in some embodiments, generate beam ellipticity characterized by varying aspect ratios. The cross section of an elliptical beam is characterized by a major axis and a minor axis. The aspect ratio discussed herein, therefore, refers to the ratio of the major axis of the beam to the minor axis of the beam. While an ellipse exhibiting an aspect ratio of 1 is a perfect circle, aspect ratios greater than 1 denote the extent to which the cross section of the beam deviates from a circular shape. In some embodiments, the beam ellipticity generated by the subject tilted beam shaping optical component is characterized by an aspect ratio ranging from greater than 1 to 25, including ranging from 3 to 20. In some embodiments, the aspect ratio is 5. In embodiments of the invention where the tilt of the tilted beam shaping optical component is adjustable, the tilt may be adjusted to achieve a desired aspect ratio.

As discussed above, the tilted beam shaping optical component is positioned between the light source and the flow cell. In some instances, the tilted beam shaping optical component is separated from the light source by a distance ranging from 60 mm to 120 mm, including from 80 mm to 100 mm. In certain instances, the tilted beam shaping optical component is separated from the light source by 90 mm. In some embodiments, the tilted beam shaping optical component is separated from the flow cell by a distance ranging from 50 mm to 200 mm, including 100 mm to 120 mm. In some embodiments, the tilted beam shaping optical component is separated from the flow cell by 110 mm. In some instances, the distance separating the light source and the tilted beam shaping optical component is adjustable, e.g., by altering the position of the light source and/or the tilted beam shaping optical component. In additional instances, the distance separating the tilted beam shaping optical component and the flow cell is adjustable. In embodiments, adjusting the distance separating the beam shaping optical component alters the magnification ratio of the imaging system. In certain embodiments, the subject flow cytometers do not include optical components positioned between the light source and the flow cell in addition to the tilted beam shaping optical component. In other embodiments, the subject flow cytometers include a fold mirror positioned between the light source and the tilted beam shaping optical component. In such embodiments, the fold mirror is configured to enable convenient adjustment and prevent stray light emitted by the light source from being detected (i.e., light from the light source that is not modulated by the tilted beam shaping optical component). In some instances, the distance from light source to the fold mirror then the concave mirror is about the ROC (radius of curvature) of the concave mirror. in some instances, the tilt angle of the fold mirror ranges from 5 to 45 degrees.

In embodiments, the tilted beam shaping optical component is a lens, i.e., a lens that focuses the beam by refraction. In such embodiments, the lens is positioned in the path of the beam produced by the light source, and the beam continues along the same optical path after passing through the lens. The subject lens may be characterized by any convenient radius of curvature and refractive index. In some embodiments, the lens is a concave lens. In other embodiments, the lens in a convex lens. In certain embodiments, the tilt of the lens generates beam ellipticity by creating astigmatism in the beam (e.g., as described above).

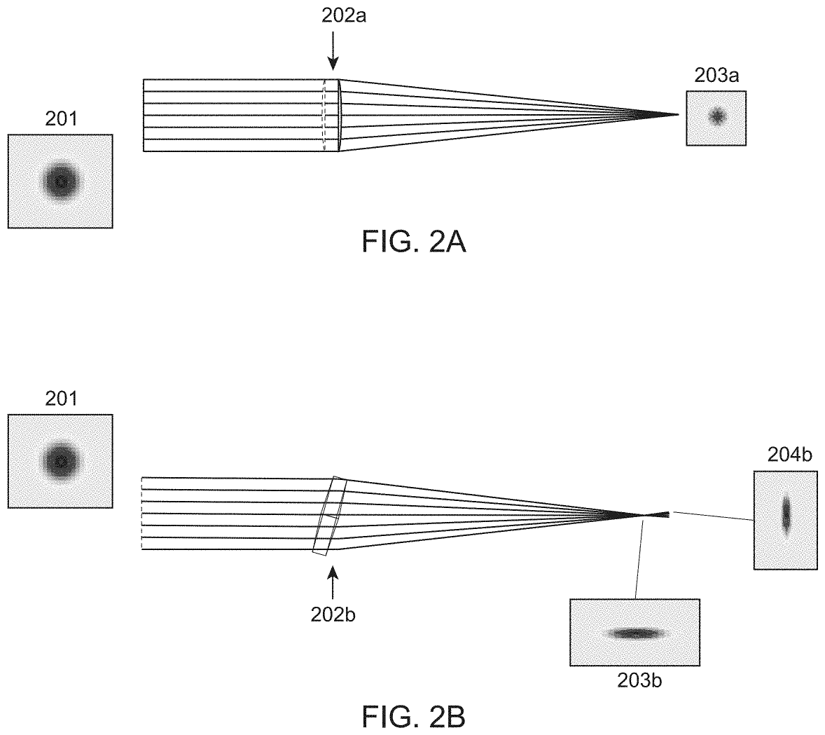

For example, FIG. 2 demonstrates how the tilt of a lens positioned between a light source and flow cell generates beam ellipticity while a straight lens does not. Beam profile 201 characterizes the circular beam emitted by the light source (not shown). FIG. 2A depicts beam shaping via a straight lens 202a (i.e., a lens that is not tilted). In other words, an imaginary axis passing through the length of straight lens 202a is parallel to a vertical axis orthogonal to the optical axis of the beam produced by the light source. The beam profile 203a observed at the beam focus produced by straight lens 202a also depicts a circular beam shape. In contrast, FIG. 2B depicts a tilted beam shaping optical component 202b in the form of a tilted lens. As shown in FIG. 2B, an imaginary axis passing through the length of the tilted lens 202b exists at an oblique angle relative to a vertical axis orthogonal to the optical axis of the beam produced by the light source. The tilt of lens 202b creates astigmatism in the beam, thereby generating beam ellipticity. Beam profiles 203b and 204b collected at two beam foci demonstrate elliptical beam shapes.

In other embodiments, the tilted beam shaping optical component is a mirror. In some embodiments, the mirror is a convex mirror. In other embodiments, the mirror is a concave mirror. In embodiments where the tilted beam shaping optical component is a mirror, achromatic imaging may be achieved such that all wavelengths of light emitted by the light source are focused in the same manner, i.e., focused at a particular locus or loci. The subject mirror may be characterized by any convenient radius of curvature. In some embodiments, the radius of curvature of the mirror ranges from 50 mm to 150 mm, including 90 mm to 110 mm. In certain embodiments, the radius of curvature of the subject mirror is 100 mm. In certain embodiments, the tilt of the mirror generates beam ellipticity by creating astigmatism in the beam (e.g., as described above).

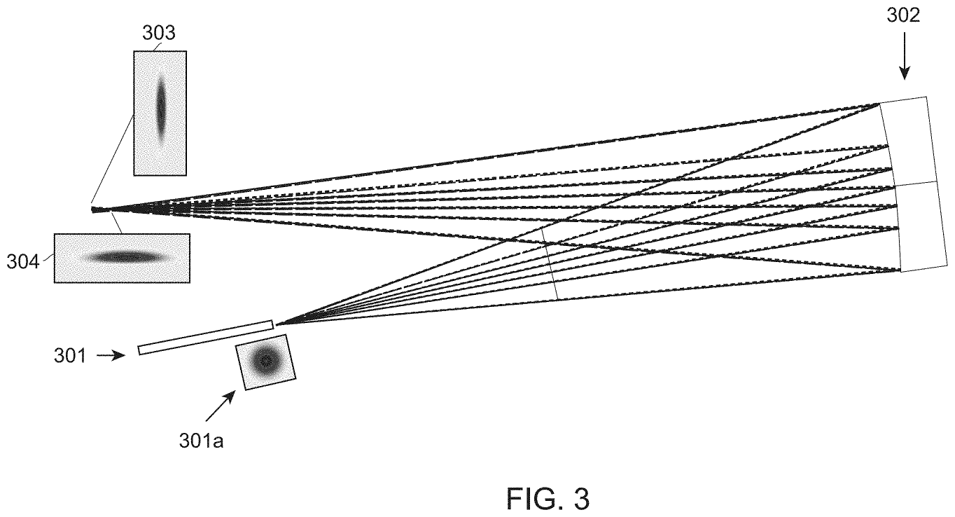

For example, FIG. 3 depicts an embodiment of the subject flow cytometers including a tilted mirror. As shown in FIG. 3, light source 301 emits a circular beam (as evidenced by beam profile 301a). Concave mirror 302 is tilted (i.e., the mirror possesses an angle of incidence such that it is tilted relative to the optical path of the beam) and reflects the beam produced by light source 301. The tilt of mirror 302 creates astigmatism in the beam, thereby generating beam ellipticity. Beam profiles 303 and 304 collected at two beam foci demonstrate elliptical beam shapes.

Any convenient light source may be employed in the flow cytometers described herein. In embodiments, the light source may be any convenient laser, such as a continuous wave laser. For example, the laser may be a diode laser, such as an ultraviolet diode laser, a visible diode laser and a near-infrared diode laser. In other embodiments, the laser may be a helium-neon (HeNe) laser. In some instances, the laser is a gas laser, such as a helium-neon laser, argon laser, krypton laser, xenon laser, nitrogen laser, CO₂ laser, CO laser, argon-fluorine (ArF) excimer laser, krypton-fluorine (KrF) excimer laser, xenon chlorine (XeCl) excimer laser or xenon-fluorine (XeF) excimer laser or a combination thereof. In other instances, the subject flow cytometers include a dye laser, such as a stilbene, coumarin or rhodamine laser. In yet other instances, lasers of interest include a metal-vapor laser, such as a helium-cadmium (HeCd) laser, helium-mercury (HeHg) laser, helium-selenium (HeSe) laser, helium-silver (HeAg) laser, strontium laser, neon-copper (NeCu) laser, copper laser or gold laser and combinations thereof. In still other instances, the subject flow cytometers include a solid-state laser, such as a ruby laser, an Nd:YAG laser, NdCrYAG laser, Er:YAG laser, Nd:YLF laser, Nd:YVO₄ laser, Nd:YCa₄O(BO₃)₃ laser, Nd:YCOB laser, titanium sapphire laser, thulim YAG laser, ytterbium YAG laser, ytterbium₂O₃ laser or cerium doped lasers and combinations thereof.

In embodiments, the laser is a semiconductor laser diode, i.e., a laser that includes semiconductor gain media (i.e., the media for laser light amplification). In some embodiments, semiconductor laser diodes are pumped with an electrical current in the region between two semiconductor materials (i.e. “n-doped” and “p-doped” materials). In embodiments, the semiconductor laser diode is an optically pumped semiconductor laser in which light is used to excite a relevant medium to a higher energy state. In other embodiments, the laser is a quantum cascade laser, e.g., a quantum cascade laser that emits near-infrared light. In still other embodiments, the laser is an edge-emitting laser diode. In still other embodiments, the laser is an external cavity diode laser, e.g., including an anti-reflection coating and/or a collimating lens. In yet other embodiments, laser is a surface emitting semiconductor laser (VCSEL/VECSEL). In some instances, Zo the laser is a continuous diode laser, such as an ultraviolet diode laser, a visible diode laser and a near-infrared diode laser. For example, the diode laser may be a 405 nm diode laser or a 488 nm diode laser. In some instances, the laser is a frequency doubled- or frequency tripled implementation of any of the above mentioned lasers. In some embodiments, components of the semiconductor laser diode may include materials such as, but not limited to, gallium arsenide (GaAs), aluminum gallium arsenide (AlGaAs), indium gallium phosphide (InGaP), gallium nitride (GaN), indium gallium arsenide (InGaAs), indium gallium arsenide nitride (GaInNAs), indium phosphide (InP), and gallium indium phosphide (GaInP), or combinations thereof. In some instances where the light source includes a laser diode, the performance of that laser diode may have been evaluated by the method described in U.S. Provisional Application No. 63/074,969, herein incorporated by reference.

Laser light sources according to certain embodiments may also include one or more optical adjustment components. The term “optical adjustment” is used herein in its conventional sense to refer to any device that is capable of changing the spatial width of irradiation or some other characteristic of irradiation from the light source, such as for example, irradiation direction, wavelength, beam width, beam intensity and focal spot.

Where the optical adjustment component is configured to move, the optical adjustment component may be configured to be moved continuously or in discrete intervals, such as for example in 0.01μ or greater increments, such as 0.05μ or greater, such as 0.1μ or greater, such as 0.5μ or greater such as 1μ or greater, such as 10μ, or greater, such as 100μ or greater, such as 500μ or greater, such as 1 mm or greater, such as 5 mm or greater, such as 10 mm or greater and including 25 mm or greater increments. Any displacement protocol may be employed to move the optical adjustment component structures, such as coupled to a moveable support stage or directly with a motor actuated translation stage, leadscrew translation assembly, geared translation device, such as those employing a stepper motor, servo motor, brushless electric motor, brushed DC motor, micro-step drive motor, high resolution stepper motor, among other types of motors.

In certain instances, the instant light source is configured to produce a flat-top beam. By “flat-top” beam it is meant a beam characterized by an intensity profile that is flat, as opposed to a Gaussian beam in which light intensity gradually increases to a peak and then subsequently decreases. In embodiments where a flat-top beam is produced, the area of the flow cell may be irradiated with a constant intensity of light. In some embodiments, the subject flow cytometers may include one or more beam homogenizers configured to transform the beam such that it exhibits a flat-top profile. In other embodiments, production of a flat-top beam involves the use of a square core fiber configured to produce a square/uniform beam output. In further embodiments, the light source is configured to produce a collimated beam, i.e., a beam including parallel rays of light that spread minimally during propagation. In such embodiments, the light source may include one or more beam collimators.

In additional embodiments, the subject light sources include multiple lasers, e.g., so that the particles in the flow cell are irradiated with multiple different wavelengths of light. Any convenient number of lasers may be included. In some embodiments, light sources of interest include 1 or more lasers configured to provide laser light for irradiation of the flow stream, such as 2 lasers or more configured to provide laser light for irradiation of the flow stream, such as 3 lasers or more, such as 4 lasers or more, such as 5 lasers or more, such as 10 lasers or more, such as 15 lasers or more, such as 25 lasers or more and including 50 lasers or more configured to provide laser light for irradiation of the flow stream. Where more than one laser is employed, the sample may be irradiated with the lasers simultaneously or sequentially, or a combination thereof. For example, the sample may be simultaneously irradiated with each of the lasers. In other embodiments, the flow stream is sequentially irradiated with each of the lasers. Where more than one light source is employed to irradiate the sample sequentially, the time each light source irradiates the sample may independently be 0.001 microseconds or more, such as 0.01 microseconds or more, such as 0.1 microseconds or more, such as 1 microsecond or more, such as 5 microseconds or more, such as 10 microseconds or more, such as 30 microseconds or more and including 60 microseconds or more. For example, methods may include irradiating the sample with the light source (e.g. laser) for a duration which ranges from 0.001 microseconds to 100 microseconds, such as from 0.01 microseconds to 75 microseconds, such as from 0.1 microseconds to 50 microseconds, such as from 1 microsecond to 25 microseconds and including from 5 microseconds to 10 microseconds. In embodiments where sample is sequentially irradiated with two or more light sources, the duration sample is irradiated by each light source may be the same or different.

The time period between irradiation by each laser may also vary, as desired, being separated independently by a delay of 0.001 microseconds or more, such as 0.01 microseconds or more, such as 0.1 microseconds or more, such as 1 microsecond or more, such as 5 microseconds or more, such as by 10 microseconds or more, such as by 15 microseconds or more, such as by 30 microseconds or more and including by 60 microseconds or more. For example, the time period between irradiation by each laser may range from 0.001 microseconds to 60 microseconds, such as from 0.01 microseconds to 50 microseconds, such as from 0.1 microseconds to 35 microseconds, such as from 1 microsecond to 25 microseconds and including from 5 microseconds to 10 microseconds. In certain embodiments, the time period between irradiation by each laser is 10 microseconds. In embodiments where sample is sequentially irradiated by more than two (i.e., 3 or more) lasers, the delay between irradiation by each laser may be the same or different.

In some instances, the light source is a light source described in U.S. Provisional Application No. 63/076,650, the disclosure of which is herein incorporated by reference. In such instances, the subject light source includes a light propagator for conveying laser light from each laser to the flow stream. In some embodiments, the light propagation component includes a fiber optic operably coupled to each laser to convey laser light from each laser to a different position on the flow stream. Depending on the number of lasers in the light source, the light propagation component may include 2 or more fiber optics, such as 3 or more fiber optics, such as 4 or more fiber optics, such as 5 or more fiber optics, such as 6 or more fiber optics, such as 7 or more fiber optics, such as 8 or more fiber optics, such as 9 or more fiber optics, such as 10 or more fiber optics, such as 25 or more fiber optics, such as 50 or more fiber optics and including 100 or more fiber optics. In certain embodiments, the light propagation component includes one or more fiber optic bundles, such as 2 or more fiber optic bundles, such as 3 or more fiber optic bundles, such as 4 or more fiber optic bundles and including 5 or more fiber optic bundles. In some embodiments, each laser is operably coupled to a single fiber optic. In other embodiments, each laser is operably coupled to more than one fiber optic, such as where each laser is operably coupled to 2 or more fiber optics, such as 3 or more fiber optics, such as 4 or more fiber optics, such as 5 or more fiber optics, such as 6 or more fiber optics, such as 7 or more fiber optics, such as 8 or more fiber optics, such as 9 or more fiber optics, such as 10 or more fiber optics, such as 25 or more fiber optics, such as 50 or more fiber optics and including 100 or more fiber optics. For example, the ratio of laser to fiber optics in the light propagation component may be 1:2 or more, such as 1:3 or more, such as 1:4 or more, such as 1:5 or more, such as 1:6 or more, such as 1:7 or more, such as 1:8 or more, such as 1:9 or more, such as 1:10 or more, such as 1:25 or more, such as 1:50 or more and including a ratio of laser to fiber optics of 1:100 or more.

Each fiber optic operably coupled to the lasers may be a single mode fiber optic or a multimode fiber optic. In some embodiments, each laser is operably coupled to a single mode fiber optic. In other embodiments, each laser is operably coupled to a multi-mode fiber optic. In yet other embodiments, one or more lasers are operably coupled to a single mode fiber optic and one or more lasers are operably coupled to a multi-mode fiber optic. In certain embodiments, each laser is operably coupled to two or more fiber optics. In one example, each laser is operably coupled to two or more single mode fiber optics. In another example, each laser is operably coupled to two or more multi-mode fiber optic. In still another example, each laser is operably coupled to one or more single mode fiber optic and one or more multi-mode fiber optic.

In some embodiments, the light propagation component includes one or more fiber optic bundles. Where the light propagation component includes one or more fiber optic bundles, the lasers may be operably coupled to a single mode fiber optic bundle or a multi-mode fiber optic bundle. In some instances, each laser is operably coupled to a single mode fiber optic bundle. In other instances, each laser is operably coupled to a multi-mode fiber optic bundle. In yet other instances, one or more lasers are operably coupled to a single mode fiber optic bundle and one or more lasers are operably coupled to a multi-mode fiber optic bundle.

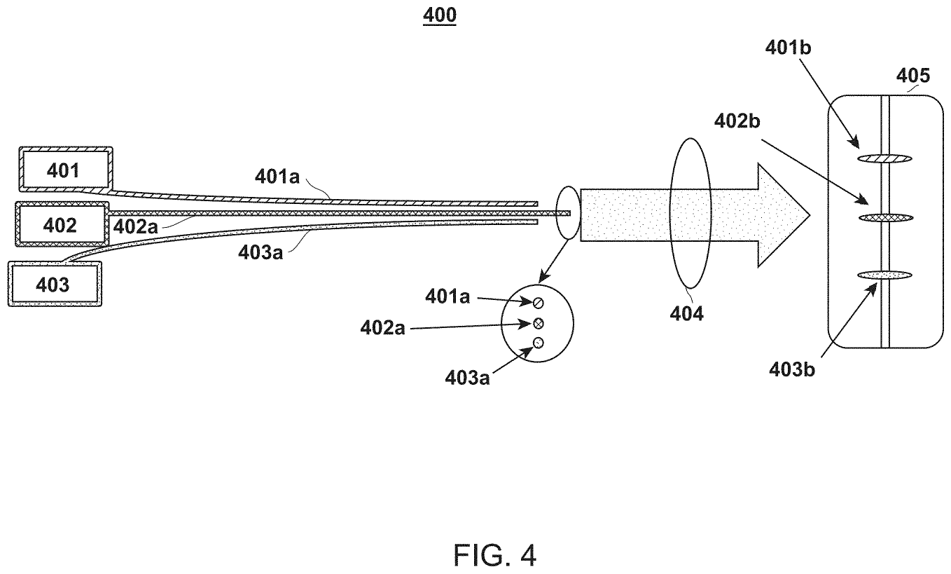

FIG. 4 depicts a light source having a plurality of lasers and a light propagation component that includes operably coupled fiber optics according to certain embodiments. Light source 400 includes a first laser 401 operably coupled to fiber optic 401a, a second laser 402 operably coupled to fiber optic 402a and a third laser 403 operably coupled to fiber optic 403a. The distal ends of fiber optics 401a, 402a and 403a are imaged onto flow stream 405 through imaging optics 404 and form beam spots 401b, 402b and 403b which irradiate at different positions downstream from each other on flow stream 405.

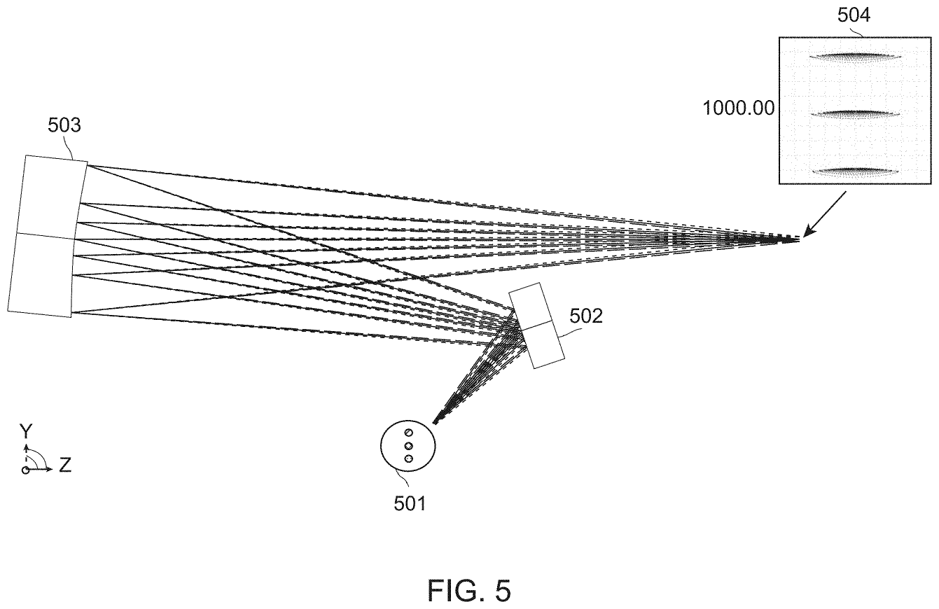

FIG. 5 depicts an embodiment of an optical system for flow cytometry that includes a tilted beam shaping optical component in the form of a concave mirror and a fiber optic bundle light source (e.g., as described above). As shown in FIG. 5, a fiber optic bundle light source 501 generates three beams of light that are subsequently reflected by a fold mirror 502. This light is subsequently reflected by tilted mirror 503, thereby creating astigmatism and beam ellipticity. Target 504 (i.e., the flow cell) demonstrates the presence of three elliptically shaped beams.

Depending on the position and pattern of irradiation of the flow stream by the laser light, the arrangement at the distal end of the fiber optics in the light propagation component may vary. In some embodiments, the fiber optics may be arranged at the distal end of the light propagation component in a cross-sectional shape such as a rectilinear cross sectional shape, e.g., squares, rectangles, trapezoids, triangles, hexagons, etc., curvilinear cross-sectional shapes, e.g., circles, ovals, as well as irregular shapes, e.g., a parabolic bottom portion coupled to a planar top portion. In certain embodiments, the distal end of the fiber optics of the light propagation component is arranged in a line pattern. In some instances, the distal end of the fiber optics of the light propagation component are arranged in a line pattern that is parallel to the longitudinal axis of the flow stream (i.e., parallel to the direction of sample flow).

In embodiments, the light propagation component is configured to convey light to different positions on a flow stream. For example, the light propagation component may be configured to convey light onto the flow stream based on arrangement of the distal end of the fiber optics. In some embodiments, the light propagation component is configured to convey laser light onto a flow stream in a predetermined pattern, such as a pattern having a rectilinear cross sectional shape, e.g., squares, rectangles, trapezoids, triangles, hexagons, etc., curvilinear cross-sectional shapes, e.g., circles, ovals, as well as irregular shapes, e.g., a parabolic bottom portion coupled to a planar top portion. In certain embodiments, the light propagation component is configured to convey light onto the flow stream in a linear pattern. In some instances, the light propagation component is configured to convey light onto the flow stream in a linear pattern that is parallel to the longitudinal axis of the flow stream (i.e., parallel to the direction of sample flow). In other instances, the light propagation component is configured to convey light onto the flow stream in a linear pattern that is orthogonal to the longitudinal axis of the flow stream (i.e., across a horizontal axis of the flow stream). The distance between the positions of irradiation on the flow stream by light conveyed by each fiber optic (e.g., when arranged in a line pattern) may be 0.0001 mm or more, such as 0.0005 mm or more, such as 0.001 mm or more, such as 0.005 mm or more, such as 0.01 mm or more, such as 0.05 mm or more, such as 0.1 mm or more, such as 0.2 mm or more, such as 0.3 mm or more, such as 0.5 mm or more, such as 0.6 mm or more, such as 0.7 mm or more, such as 0.8 mm or more, such as 0.9 mm or more, such as 1.0 mm or more, such as 2 mm or more and including 3 mm or more. In some embodiments, the distance between the position of irradiation on the flow stream by light conveyed by each fiber optic ranges from 0.0001 mm to 5 mm, such as from 0.0005 mm to 4.5 mm, such as from 0.001 mm to 4.0 mm, such as from 0.005 mm to 3.5 mm, such as from 0.01 mm to 3.0 mm, such as from 0.05 mm to 2.5 mm, such as from 0.1 mm to 2.0 mm and including from 0.2 mm to 1.5 mm.

In some embodiments, the light propagation component is configured to convey light from a first fiber optic to a first position on the flow stream and to convey light from a second fiber optic to a second position on the flow stream. In some instances, the second position is downstream from the first position on the flow stream. For example, the second position may be 0.0001 mm or more downstream from the first position on the flow stream, such as 0.0005 mm or more, such as 0.001 mm or more, such as 0.005 mm or more, such as 0.01 mm or more, such as 0.05 mm or more, such as 0.1 mm or more, such as 0.2 mm or more, such as 0.3 mm or more, such as 0.5 mm or more, such as 0.6 mm or more, such as 0.7 mm or more, such as 0.8 mm or more, such as 0.9 mm or more, such as 1.0 mm or more, such as 2 mm or more and including 3 mm or more downstream from the first position on the flow stream. In some instances, the second position is downstream from the first position on the flow stream by a distance that ranges from 0.0001 mm to 5 mm, such as from 0.0005 mm to 4.5 mm, such as from 0.001 mm to 4.0 mm, such as from 0.005 mm to 3.5 mm, such as from 0.01 mm to 3.0 mm, such as from 0.05 mm to 2.5 mm, such as from 0.1 mm to 2.0 mm and including from 0.2 mm to 1.5 mm. In certain embodiments, the second position is 0.2 mm or more downstream from the first position on the flow stream.

Aspects of the flow cytometers also include a forward scatter detector configured to detect forward scattered light. The number of forward scatter detectors in the subject flow cytometers may vary, as desired. For example, the subject flow cytometers may include 1 forward scatter detector or multiple forward scatter detectors, such as 2 or more, such as 3 or more, such as 4 or more, and including 5 or more. In certain embodiments, flow cytometers include 1 forward scatter detector. In other embodiments, flow cytometers include 2 forward scatter detectors Any convenient detector for detecting collected light may be used in the forward scatter detector described herein. Detectors of interest may include, but are not limited to, optical sensors or detectors, such as active-pixel sensors (APSs), avalanche photodiodes, image sensors, charge-coupled devices (CCDs), intensified charge-coupled devices (ICCDs), light emitting diodes, photon counters, bolometers, pyroelectric detectors, photoresistors, photovoltaic cells, photodiodes, photomultiplier tubes (PMTs), phototransistors, quantum dot photoconductors or photodiodes and combinations thereof, among other detectors. In certain embodiments, the collected light is measured with a charge-coupled device (CCD), semiconductor charge-coupled devices (CCD), active pixel sensors (APS), complementary metal-oxide semiconductor (CMOS) image sensors or N-type metal-oxide semiconductor (NMOS) image sensors. In certain embodiments, the detector is a photomultiplier tube, such as a photomultiplier tube having an active detecting surface area of each region that ranges from 0.01 cm² to 10 cm², such as from 0.05 cm² to 9 cm², such as from, such as from 0.1 cm² to 8 cm², such as from 0.5 cm² to 7 cm² and including from 1 cm² to 5 cm².

Where the flow cytometers include multiple forward scatter detectors, each detector may be the same, or the collection of detectors may be a combination of different types of detectors. For example, where the subject flow cytometers include two forward scatter detectors, in some embodiments the first forward scatter detector is a CCD-type device and the second forward scatter detector (or imaging sensor) is a CMOS-type device. In other embodiments, both the first and second forward scatter detectors are CCD-type devices. In yet other embodiments, both the first and second forward scatter detectors are CMOS-type devices. In still other embodiments, the first forward scatter detector is a CCD-type device and the second forward scatter detector is a photomultiplier tube (PMT). In still other embodiments, the first forward scatter detector is a CMOS-type device and the second forward scatter detector is a photomultiplier tube. In yet other embodiments, both the first and second forward scatter detectors are photomultiplier tubes.

In embodiments, the forward scatter detector is configured to measure light continuously or in discrete intervals. In some instances, detectors of interest are configured to take measurements of the collected light continuously. In other instances, detectors of interest are configured to take measurements in discrete intervals, such as measuring light every 0.001 millisecond, every 0.01 millisecond, every 0.1 millisecond, every 1 millisecond, every 10 milliseconds, every 100 milliseconds and including every 1000 milliseconds, or some other interval.

Embodiments of the invention also include a light dispersion/separator module positioned between the flow cell and the forward scatter detector. Light dispersion devices of interest include but are not limited to, colored glass, bandpass filters, interference filters, dichroic mirrors, diffraction gratings, monochromators and combinations thereof, among other wavelength separating devices. In some embodiments, a bandpass filter is positioned between the flow cell and the forward scatter detector. In other embodiments, more than one bandpass filter is positioned between the flow cell and the forward scatter detector, such as, for example, 2 or more, 3 or more, 4 or more, and including 5 or more. In embodiments, the bandpass filters have a minimum bandwidth ranging from 2 nm to 100 nm, such as from 3 nm to 95 nm, such as from 5 nm to 95 nm, such as from 10 nm to 90 nm, such as from 12 nm to 85 nm, such as from 15 nm to 80 nm and including bandpass filters having minimum bandwidths ranging from 20 nm to 50 nm. wavelengths and reflects light with other wavelengths to the forward scatter detector.

Certain embodiments of the invention include a side scatter detector configured to detect side scatter wavelengths of light (e.g., light refracted and reflected from the surfaces and internal structures of the particle). In other embodiments, flow cytometers include multiple side scatter detectors, such as 2 or more, such as 3 or more, such as 4 or more, and including 5 or more.

Any convenient detector for detecting collected light may be used in the side scatter detector described herein. Detectors of interest may include, but are not limited to, optical sensors or detectors, such as active-pixel sensors (APSs), avalanche photodiodes, image sensors, charge-coupled devices (CCDs), intensified charge-coupled devices (ICCDs), light emitting diodes, photon counters, bolometers, pyroelectric detectors, photoresistors, photovoltaic cells, photodiodes, photomultiplier tubes (PMTs), phototransistors, quantum dot photoconductors or photodiodes and combinations thereof, among other detectors. In certain embodiments, the collected light is measured with a charge-coupled device (CCD), semiconductor charge-coupled devices (CCD), active pixel sensors (APS), complementary metal-oxide semiconductor (CMOS) image sensors or N-type metal-oxide semiconductor (NMOS) image sensors. In certain embodiments, the detector is a photomultiplier tube, such as a photomultiplier tube having an active detecting surface area of each region that ranges from 0.01 cm² to 10 cm², such as from 0.05 cm² to 9 cm², such as from, such as from 0.1 cm² to 8 cm², such as from 0.5 cm² to 7 cm² and including from 1 cm² to 5 cm².

Where the subject flow cytometers include multiple side scatter detectors, each side scatter detector may be the same, or the collection of side scatter detectors may be a combination of different types of detectors. For example, where the subject flow cytometers include two side scatter detectors, in some embodiments the first side scatter detector is a CCD-type device and the second side scatter detector (or imaging sensor) is a CMOS-type device. In other embodiments, both the first and second side scatter detectors are CCD-type devices. In yet other embodiments, both the first and second side scatter detectors are CMOS-type devices. In still other embodiments, the first side scatter detector is a CCD-type device and the second side scatter detector is a photomultiplier tube (PMT). In still other embodiments, the first side scatter detector is a CMOS-type device and the second side scatter detector is a photomultiplier tube. In yet other embodiments, both the first and second side scatter detectors are photomultiplier tubes.

Embodiments of the invention also include a light dispersion/separator module positioned between the flow cell and the side scatter detector. Light dispersion devices of interest include but are not limited to, colored glass, bandpass filters, interference filters, dichroic mirrors, diffraction gratings, monochromators and combinations thereof, among other wavelength separating devices.

In embodiments, the subject flow cytometers also include a fluorescent light detector configured to detect one or more fluorescent wavelengths of light. In other embodiments, flow cytometers include multiple fluorescent light detectors such as 2 or more, such as 3 or more, such as 4 or more, 5 or more, 10 or more, 15 or more, and including 20 or more.

Any convenient detector for detecting collected light may be used in the fluorescent light detector described herein. Detectors of interest may include, but are not limited to, optical sensors or detectors, such as active-pixel sensors (APSs), avalanche photodiodes, image sensors, charge-coupled devices (CCDs), intensified charge-coupled devices (ICCDs), light emitting diodes, photon counters, bolometers, pyroelectric detectors, photoresistors, photovoltaic cells, photodiodes, photomultiplier tubes (PMTs), phototransistors, quantum dot photoconductors or photodiodes and combinations thereof, among other detectors. In certain embodiments, the collected light is measured with a charge-coupled device (CCD), semiconductor charge-coupled devices (CCD), active pixel sensors (APS), complementary metal-oxide semiconductor (CMOS) image sensors or N-type metal-oxide semiconductor (NMOS) image sensors. In certain embodiments, the detector is a photomultiplier tube, such as a photomultiplier tube having an active detecting surface area of each region that ranges from 0.01 cm² to 10 cm², such as from 0.05 cm² to 9 cm², such as from, such as from 0.1 cm² to 8 cm², such as from 0.5 cm² to 7 cm² and including from 1 cm² to 5 cm².

Where the subject flow cytometers include multiple fluorescent light detectors, each fluorescent light detector may be the same, or the collection of fluorescent light detectors may be a combination of different types of detectors. For example, where the subject flow cytometers include two fluorescent light detectors, in some embodiments the first fluorescent light detector is a CCD-type device and the second fluorescent light detector (or imaging sensor) is a CMOS-type device. In other embodiments, both the first and second fluorescent light detectors are CCD-type devices. In yet other embodiments, both the first and second fluorescent light detectors are CMOS-type devices. In still other embodiments, the first fluorescent light detector is a CCD-type device and the second fluorescent light detector is a photomultiplier tube (PMT). In still other embodiments, the first fluorescent light detector is a CMOS-type device and the second fluorescent light detector is a photomultiplier tube. In yet other embodiments, both the first and second fluorescent light detectors are photomultiplier tubes.

Embodiments of the invention also include a light dispersion/separator module positioned between the flow cell and the fluorescent light detector. Light dispersion devices of interest include but are not limited to, colored glass, bandpass filters, interference filters, dichroic mirrors, diffraction gratings, monochromators and combinations thereof, among other wavelength separating devices.

In embodiments of the present disclosure, fluorescent light detectors of interest are configured to measure collected light at one or more wavelengths, such as at 2 or more wavelengths, such as at 5 or more different wavelengths, such as at 10 or more different wavelengths, such as at 25 or more different wavelengths, such as at 50 or more different wavelengths, such as at 100 or more different wavelengths, such as at 200 or more different wavelengths, such as at 300 or more different wavelengths and including measuring light emitted by a sample in the flow stream at 400 or more different wavelengths. In some embodiments, 2 or more detectors in a flow cytometer as described herein are configured to measure the same or overlapping wavelengths of collected light.

In some embodiments, fluorescent light detectors of interest are configured to measure collected light over a range of wavelengths (e.g., 200 nm-1000 nm). In certain embodiments, detectors of interest are configured to collect spectra of light over a range of wavelengths. For example, flow cytometers may include one or more detectors configured to collect spectra of light over one or more of the wavelength ranges of 200 nm-1000 nm. In yet other embodiments, detectors of interest are configured to measure light emitted by a sample in the flow stream at one or more specific wavelengths. For example, flow cytometers may include one or more detectors configured to measure light at one or more of 450 nm, 518 nm, 519 nm, 561 nm, 578 nm, 605 nm, 607 nm, 625 nm, 650 nm, 660 nm, 667 nm, 670 nm, 668 nm, 695 nm, 710 nm, 723 nm, 780 nm, 785 nm, 647 nm, 617 nm and any combinations thereof. In certain embodiments, one or more detectors may be configured to be paired with specific fluorophores, such as those used with the sample in a fluorescence assay.

Suitable flow cytometry systems may include, but are not limited to those described in Ormerod (ed.), Flow Cytometry: A Practical Approach, Oxford Univ. Press (1997); Jaroszeski et al. (eds.), Flow Cytometry Protocols, Methods in Molecular Biology No. 91, Humana Press (1997); Practical Flow Cytometry, 3rd ed., Wiley-Liss (1995); Virgo, et al. (2012) Ann Clin Biochem. January; 49(pt 1):17-28; Linden, et. al., Semin Throm Hemost. 2004 October; 30(5):502-11; Alison, et al. J Pathol, 2010 December; 222(4):335-344; and Herbig, et al. (2007) Crit Rev Ther Drug Carrier Syst. 24(3):203-255; the disclosures of which are incorporated herein by reference. In certain instances, flow cytometry systems of interest include BD Biosciences FACSCanto™ flow cytometer, BD Biosciences FACSCanto™ II flow cytometer, BD Accuri™ flow cytometer, BD Accuri™ C6 Plus flow cytometer, BD Biosciences FACSCelesta™ flow cytometer, BD Biosciences FACSLyric™ flow cytometer, BD Biosciences FACSVerse™ flow cytometer, BD Biosciences FACSymphony™ flow cytometer, BD Biosciences LSRFortessa™ flow cytometer, BD Biosciences LSRFortessa™ X-20 flow cytometer, BD Biosciences FACSPresto™ flow cytometer, BD Biosciences FACSVia™ flow cytometer and BD Biosciences FACSCalibur™ cell sorter, a BD Biosciences FACSCount™ cell sorter, BD Biosciences FACSLyric™ cell sorter, BD Biosciences Via™ cell sorter, BD Biosciences Influx™ cell sorter, BD Biosciences Jazz™ cell sorter, BD Biosciences Aria™ cell sorter, BD Biosciences FACSAria™ II cell sorter, BD Biosciences FACSAria™ III cell sorter, BD Biosciences FACSAria™ Fusion cell sorter and BD Biosciences FACSMelody™ cell sorter, BD Biosciences FACSymphony™ S6 cell sorter or the like.

In some embodiments, the subject systems are flow cytometric systems, such those described in U.S. Pat. Nos. 10,663,476; 10,620,111; 10,613,017; 10,605,713; 10,585,031; 10,578,542; 10,578,469; 10,481,074; 10,302,545; 10,145,793; 10,113,967; 10,006,852; 9,952,076; 9,933,341; 9,726,527; 9,453,789; 9,200,334; 9,097,640; 9,095,494; 9,092,034; 8,975,595; 8,753,573; 8,233,146; 8,140,300; 7,544,326; 7,201,875; 7,129,505; 6,821,740; 6,813,017; 6,809,804; 6,372,506; 5,700,692; 5,643,796; 5,627,040; 5,620,842; 5,602,039; 4,987,086; 4,498,766; the disclosures of which are herein incorporated by reference in their entirety.

In certain instances, flow cytometry systems of the invention are configured for imaging particles in a flow stream by fluorescence imaging using radiofrequency tagged emission (FIRE), such as those described in Diebold, et al. Nature Photonics Vol. 7(10); 806-810 (2013) as well as described in U.S. Pat. Nos. 9,423,353; 9,784,661; 9,983,132; 10,006,852; 10,078,045; 10,036,699; 10,222,316; 10,288,546; 10,324,019; 10,408,758; 10,451,538; 10,620,111; and U.S. Patent Publication Nos. 2017/0133857; 2017/0328826; 2017/0350803; 2018/0275042; 2019/0376895 and 2019/0376894 the disclosures of which are herein incorporated by reference.

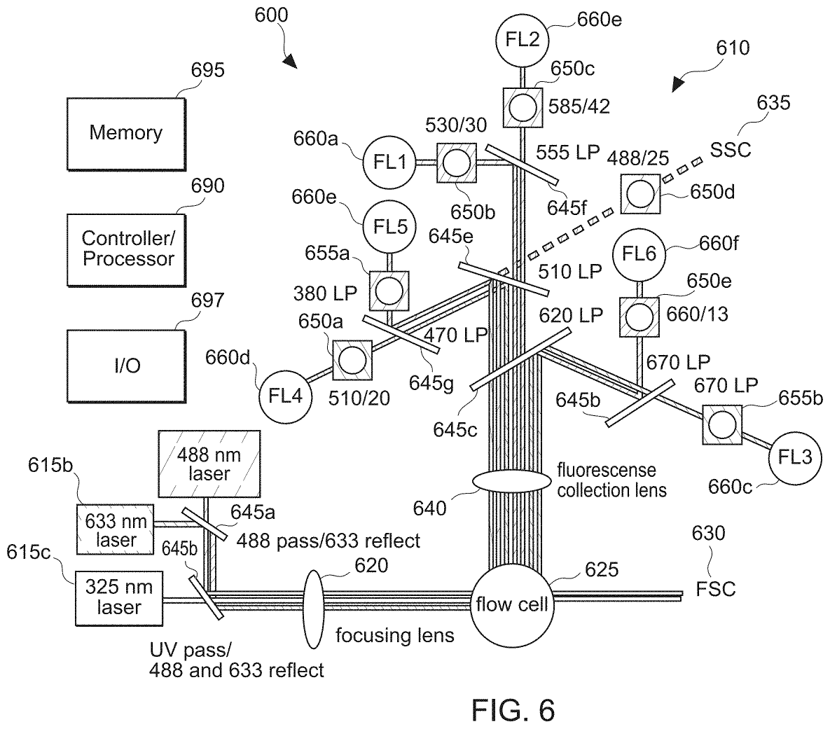

FIG. 6 shows a system 600 for flow cytometry in accordance with an illustrative embodiment of the present invention. The system 600 includes a flow cytometer 610, a controller/processor 690 and a memory 695. The flow cytometer 610 includes one or more excitation lasers 615a-615c, a tilted beam shaping optical component in the form of lens 620, a flow chamber 625, a forward scatter detector 630, a side scatter detector 635, a fluorescence collection lens 640, one or more beam splitters 645a-645g, one or more bandpass filters 650a-650e, one or more longpass (“LP”) filters 655a-655b, and one or more fluorescent light detectors 660a-660f.

The excitation lasers 615a-c emit light in the form of a laser beam. The wavelengths of the laser beams emitted from excitation lasers 615a-615c are 488 nm, 633 nm, and 325 nm, respectively, in the example system of FIG. 6. The laser beams are first directed through one or more of beam splitters 645a and 645b. Beam splitter 645a transmits light at 488 nm and reflects light at 633 nm. Beam splitter 645b transmits UV light (light with a wavelength in the range of 10 to 400 nm) and reflects light at 488 nm and 633 nm.

The laser beams are then directed to a tilted beam shaping optical component in the form of lens 620, which generates beam ellipticity (e.g., as described above) and focuses the beams onto the portion of a fluid stream where particles of a sample are located, within the flow chamber 625. The flow chamber is part of a fluidics system which directs particles, typically one at a time, in a stream to the focused laser beam for interrogation. The flow chamber can comprise a flow cell in a benchtop cytometer or a nozzle tip in a stream-in-air cytometer.

The light from the laser beam(s) interacts with the particles in the sample by diffraction, refraction, reflection, scattering, and absorption with re-emission at various different wavelengths depending on the characteristics of the particle such as its size, internal structure, and the presence of one or more fluorescent molecules attached to or naturally present on or in the particle. The fluorescence emissions as well as the diffracted light, refracted light, reflected light, and scattered light may be routed to one or more of the forward scatter detector 630, side scatter detector 635, and the one or more fluorescent light detectors 660a-660f through one or more of the beam splitters 645a-645g, the bandpass filters 650a-650e, the longpass filters 655a-655b, and the fluorescence collection lens 640.

The fluorescence collection lens 640 collects light emitted from the particle-laser beam interaction and routes that light towards one or more beam splitters and filters. Bandpass filters, such as bandpass filters 650a-650e, allow a narrow range of wavelengths to pass through the filter. For example, bandpass filter 650a is a 510/20 filter. The first number represents the center of a spectral band. The second number provides a range of the spectral band. Thus, a 510/20 filter extends 10 nm on each side of the center of the spectral band, or from 500 nm to 520 nm. Shortpass filters transmit wavelengths of light equal to or shorter than a specified wavelength. Longpass filters, such as longpass filters 655a-655b, transmit wavelengths of light equal to or longer than a specified wavelength of light. For example, longpass filter 655a, which is a 670 nm longpass filter, transmits light equal to or longer than 670 nm. Filters are often selected to optimize the specificity of a detector for a particular fluorescent dye. The filters can be configured so that the spectral band of light transmitted to the detector is close to the emission peak of a fluorescent dye.

Beam splitters direct light of different wavelengths in different directions. Beam splitters can be characterized by filter properties such as shortpass and longpass. For example, beam splitter 605g is a 620 SP beam splitter, meaning that the beam splitter 645g transmits wavelengths of light that are 620 nm or shorter and reflects wavelengths of light that are longer than 620 nm in a different direction. In one embodiment, the beam splitters 645a-645g can comprise optical mirrors, such as dichroic mirrors.

The forward scatter detector 630 is positioned off axis from the direct beam through the flow cell and is configured to detect diffracted light, the excitation light that travels through or around the particle in mostly a forward direction. The intensity of the light detected by the forward scatter detector is dependent on the overall size of the particle. The forward scatter detector can include a photodiode. The side scatter detector 635 is configured to detect refracted and reflected light from the surfaces and internal structures of the particle, and tends to increase with increasing particle complexity of structure. The fluorescence emissions from fluorescent molecules associated with the particle can be detected by the one or more fluorescent light detectors 660a-660f. The side scatter detector 635 and fluorescent light detectors can include photomultiplier tubes. The signals detected at the forward scatter detector 630, the side scatter detector 635 and the fluorescent detectors can be converted to electronic signals (voltages) by the detectors. This data can provide information about the sample.

In operation, cytometer operation is controlled by a controller/processor 690, and the measurement data from the detectors can be stored in the memory 695 and processed by the controller/processor 690. Although not shown explicitly, the controller/processor 690 is coupled to the detectors to receive the output signals therefrom, and may also be coupled to electrical and electromechanical components of the flow cytometer 600 to control the lasers, fluid flow parameters, and the like. Input/output (I/O) capabilities 697 may be provided also in the system. The memory 695, controller/processor 690, and I/O 697 may be entirely provided as an integral part of the flow cytometer 610. In such an embodiment, a display may also form part of the I/O capabilities 697 for presenting experimental data to users of the cytometer 600. Alternatively, some or all of the memory 695 and controller/processor 690 and I/O capabilities may be part of one or more external devices such as a general purpose computer. In some embodiments, some or all of the memory 695 and controller/processor 690 can be in wireless or wired communication with the cytometer 610. The controller/processor 690 in conjunction with the memory 695 and the I/O 697 can be configured to perform various functions related to the preparation and analysis of a flow cytometer experiment.

The system illustrated in FIG. 6 includes six different detectors that detect fluorescent light in six different wavelength bands (which may be referred to herein as a “filter window” for a given detector) as defined by the configuration of filters and/or splitters in the beam path from the flow cell 625 to each detector. Different fluorescent molecules used for a flow cytometer experiment will emit light in their own characteristic wavelength bands. The particular fluorescent labels used for an experiment and their associated fluorescent emission bands may be selected to generally coincide with the filter windows of the detectors. However, as more detectors are provided, and more labels are utilized, perfect correspondence between filter windows and fluorescent emission spectra is not possible. It is generally true that although the peak of the emission spectra of a particular fluorescent molecule may lie within the filter window of one particular detector, some of the emission spectra of that label will also overlap the filter windows of one or more other detectors. This may be referred to as spillover. The I/O 697 can be configured to receive data regarding a flow cytometer experiment having a panel of fluorescent labels and a plurality of cell populations having a plurality of markers, each cell population having a subset of the plurality of markers. The I/O 697 can also be configured to receive biological data assigning one or more markers to one or more cell populations, marker density data, emission spectrum data, data assigning labels to one or more markers, and cytometer configuration data. Flow cytometer experiment data, such as label spectral characteristics and flow cytometer configuration data can also be stored in the memory 695. The controller/processor 690 can be configured to evaluate one or more assignments of labels to markers.

One of skill in the art will recognize that a flow cytometer in accordance with an embodiment of the present invention is not limited to the flow cytometer depicted in FIG. 6, but can include any flow cytometer known in the art. For example, a flow cytometer may have any number of lasers, beam splitters, filters, and detectors at various wavelengths and in various different configurations.

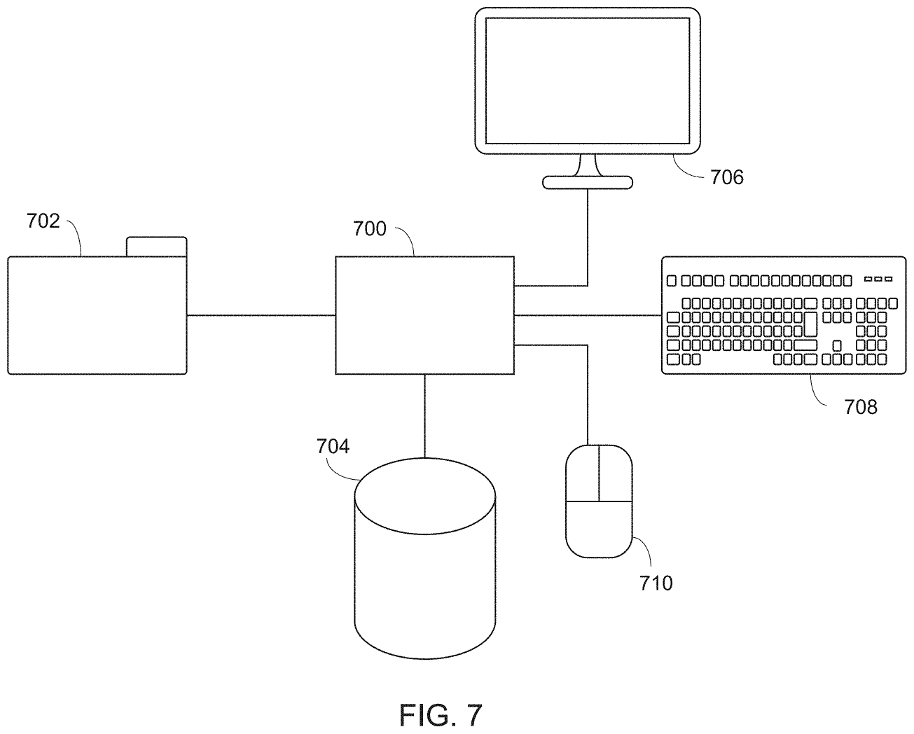

FIG. 7 shows a functional block diagram for one example of a processor 700, for analyzing and displaying data. A processor 700 can be configured to implement a variety of processes for controlling graphic display of biological events. A flow cytometer 702 can be configured to acquire flow cytometer data by analyzing a biological sample (e.g., as described above). The apparatus can be configured to provide biological event data to the processor 700. A data communication channel can be included between the flow cytometer 702 and the processor 700. The data can be provided to the processor 700 via the data communication channel. The processor 700 can be configured to provide a graphical display including plots (e.g., as described above) to display 706. The processor 700 can be further configured to render a gate around populations of flow cytometer data shown by the display device 706, overlaid upon the plot, for example. In some embodiments, the gate can be a logical combination of one or more graphical regions of interest drawn upon a single parameter histogram or bivariate plot. In some embodiments, the display can be used to display analyte parameters or saturated detector data.

The processor 700 can be further configured to display flow cytometer data on the display device 706 within the gate differently from other events in the fluorescent flow cytometer data outside of the gate. For example, the processor 700 can be configured to render the color of fluorescent flow cytometer data contained within the gate to be distinct from the color of fluorescent flow cytometer data outside of the gate. In this way, the processor 700 may be configured to render different colors to represent each unique population of data. The display device 706 can be implemented as a monitor, a tablet computer, a smartphone, or other electronic device configured to present graphical interfaces.

The processor 700 can be configured to receive a gate selection signal identifying the gate from a first input device. For example, the first input device can be implemented as a mouse 710. The mouse 710 can initiate a gate selection signal to the processor 700 identifying the population to be displayed on or manipulated via the display device 706 (e.g., by clicking on or in the desired gate when the cursor is positioned there). In some implementations, the first device can be implemented as the keyboard 708 or other means for providing an input signal to the processor 700 such as a touchscreen, a stylus, an optical detector, or a voice recognition system. Some input devices can include multiple inputting functions. In such implementations, the inputting functions can each be considered an input device. For example, as shown in FIG. 7, the mouse 710 can include a right mouse button and a left mouse button, each of which can generate a triggering event.

The triggering event can cause the processor 700 to alter the manner in which the fluorescent flow cytometer data is displayed, which portions of the data is actually displayed on the display device 706, and/or provide input to further processing such as selection of a population of interest for analysis.

In some embodiments, the processor 700 can be configured to detect when gate selection is initiated by the mouse 710. The processor 700 can be further configured to automatically modify plot visualization to facilitate the gating process. The modification can be based on the specific distribution of data received by the processor 700.

The processor 700 can be connected to a storage device 704. The storage device 704 can be configured to receive and store data from the processor 700. The storage device 704 can be further configured to allow retrieval of data, such as flow cytometer data, by the processor 700.

A display device 706 can be configured to receive display data from the processor 700. The display data can comprise plots of fluorescent flow cytometer data and gates outlining sections of the plots. The display device 706 can be further configured to alter the information presented according to input received from the processor 700 in conjunction with input from apparatus 702, the storage device 704, the keyboard 708, and/or the mouse 710.

In some implementations the processor 700 can generate a user interface to receive example events for sorting. For example, the user interface can include a control for receiving example events or example images. The example events or images or an example gate can be provided prior to collection of event data for a sample, or based on an initial set of events for a portion of the sample.

### Methods of Analyzing a Sample in a Flow Cytometer Including a Tilted Beam Shaping Optical Component

Aspects of the invention further involve methods of analyzing a sample in a flow cytometer including a tilted beam shaping optical component. In embodiments, methods involve introducing a sample into a flow cytometer including a flow cell, a light source configured to produce a beam for irradiating particles in the flow cell at an interrogation point, and a tilted beam shaping optical component positioned between the light source and the flow cell, wherein the tilted beam shaping optical is configured to generate ellipticity in the beam. After the sample is introduced into the flow cytometer, methods further include detecting particle-modulated light emitted from the flow cell to analyze the sample.

As discussed above, aspects of the instant methods include irradiating a sample in a flow cytometer having a tilted beam shaping optical component. In such embodiments, light from the sample is detected to generate populations of related particles based at least in part on the measurements of the detected light. In some instances, the sample is a biological sample. The term “biological sample” is used in its conventional sense to refer to a whole organism, plant, fungi or a subset of animal tissues, cells or component parts which may in certain instances be found in blood, mucus, lymphatic fluid, synovial fluid, cerebrospinal fluid, saliva, bronchoalveolar lavage, amniotic fluid, amniotic cord blood, urine, vaginal fluid and semen. As such, a “biological sample” refers to both the native organism or a subset of its tissues as well as to a homogenate, lysate or extract prepared from the organism or a subset of its tissues, including but not limited to, for example, plasma, serum, spinal fluid, lymph fluid, sections of the skin, respiratory, gastrointestinal, cardiovascular, and genitourinary tracts, tears, saliva, milk, blood cells, tumors, organs. Biological samples may be any type of organismic tissue, including both healthy and diseased tissue (e.g., cancerous, malignant, necrotic, etc.). In certain embodiments, the biological sample is a liquid sample, such as blood or derivative thereof, e.g., plasma, tears, urine, semen, etc., where in some instances the sample is a blood sample, including whole blood, such as blood obtained from venipuncture or fingerstick (where the blood may or may not be combined with any reagents prior to assay, such as preservatives, anticoagulants, etc.).

In certain embodiments the source of the sample is a “mammal” or “mammalian”, where these terms are used broadly to describe organisms which are within the class mammalia, including the orders carnivore (e.g., dogs and cats), rodentia (e.g., mice, guinea pigs, and rats), and primates (e.g., humans, chimpanzees, and monkeys). In some instances, the subjects are humans. The methods may be applied to samples obtained from human subjects of both genders and at any stage of development (i.e., neonates, infant, juvenile, adolescent, adult), where in certain embodiments the human subject is a juvenile, adolescent or adult. While the present invention may be applied to samples from a human subject, it is to be understood that the methods may also be carried-out on samples from other animal subjects (that is, in “non-human subjects”) such as, but not limited to, birds, mice, rats, dogs, cats, livestock and horses.

In some embodiments, the tilted beam shaping optical components described herein are configured to produce beam ellipticity by creating astigmatism in the beam. “Astigmatism” is referred to in its conventional sense to describe a beam in which rays propagating in perpendicular planes possess different foci, i.e., the beam is focused at multiple points along the beam axis. In such embodiments, the subject tilted beam shaping optical component creates astigmatism based on tilt, i.e., the extent to which the tilted beam shaping optical component is slanted. In other words, in embodiments where the beam passes through the beam shaping optical component, the tilted beam shaping optical component is characterized by an imaginary axis passing through the length of the beam shaping optical component existing at an oblique angle relative to a vertical axis orthogonal to the optical axis of the beam produced by the light source. In embodiments, the tilt of the tilted beam shaping optical component is characterized by an angle of incidence, i.e., the angle between a ray of light incident on the surface of the tilted beam shaping optical component and the line perpendicular to said component at the point of incidence. In some embodiments, the tilt of the tilted beam shaping optical component ranges from 1 degree to 50 degrees, including 1 degree to 20 degrees, and further including 5 degrees to 7 degrees. In some embodiments, the tilt of the tilted beam shaping optical component may be 5 degrees, 6, degrees, 7, degrees, 8 degrees, 9 degrees and including 10 degrees. In certain embodiments, the tilt of the tilted beam shaping optical component is adjustable. In some embodiments, the tilt of the tilted beam shaping optical is manually adjustable by a user so that a desired amount of beam astigmatism is achieved. In other embodiments, the tilt of the tilted beam shaping optical component is mechanically adjustable. In such embodiments, tilt may be adjusted by a motor, such as a stepper motor, servo motor, brushless electric motor, brushed DC motor, micro-step drive motor, high resolution stepper motor, among other types of motors.

As discussed above, the tilted beam shaping optical component is positioned between the light source and the flow cell. In some instances, the tilted beam shaping optical component is separated from the light source by a distance ranging from 60 mm to 120 mm, including from 80 mm to 100 mm. In certain instances, the tilted beam shaping optical component is separated from the light source by 90 mm. In some embodiments, the tilted beam shaping optical component is separated from the flow cell by a distance ranging from 50 mm to 200 mm, including 100 mm to 120 mm. In some embodiments, the tilted beam shaping optical component is separated from the flow cell by 110 mm. In some instances, the distance separating the light source and the tilted beam shaping optical component is adjustable. In additional instances, the distance separating the tilted beam shaping optical component and the flow cell is adjustable. In embodiments, adjusting the distance separating the beam shaping optical component alters the magnification ratio of the imaging system.

The tilted beam shaping optical components described herein may, in some embodiments, generate beam ellipticity characterized by varying aspect ratios. The cross section of an elliptical beam is characterized by a major axis and a minor axis. The aspect ratio discussed herein, therefore, refers to the ratio of the major axis of the beam to the minor axis of the beam. While an ellipse exhibiting an aspect ratio of 1 is a perfect circle, aspect ratios greater than 1 denote the extent to which the cross section of the beam deviates from a circular shape. In some embodiments, the beam ellipticity generated by the subject tilted beam shaping optical component is characterized by an aspect ratio ranging from greater than 1 to 25, including ranging from 3 to 20. In some embodiments, the aspect ratio is 5. In embodiments of the invention where the tilt of the tilted beam shaping optical component is adjustable, methods include adjusting the tilt to achieve a desired aspect ratio.

In embodiments, the tilted beam shaping optical component is a lens, i.e., a lens that focuses the beam by refraction. In such embodiments, the lens is positioned in the path of the beam produced by the light source, and the beam continues along the same path after passing through the lens. The subject lens may be characterized by any convenient radius of curvature and refractive index. In some embodiments, the lens is a concave lens. In other embodiments, the lens in a convex lens. In certain embodiments, the tilt of the lens generates beam ellipticity by creating astigmatism in the beam (e.g., as described above).

In other embodiments, the tilted beam shaping optical component is a mirror. In some embodiments, the mirror is a convex mirror. In other embodiments, the mirror is a concave mirror. In embodiments where the tilted beam shaping optical component is a mirror, achromatic imaging may be achieved such that all wavelengths of light emitted by the light source are focused in the same manner, i.e., focused at a particular locus or loci. The subject mirror may be characterized by any convenient radius of curvature. In some embodiments, the radius of curvature of the mirror ranges from 50 mm to 150 mm, including 90 mm to 110 mm. In certain embodiments, the radius of curvature of the subject mirror is 100 mm. In certain embodiments, the tilt of the mirror generates beam ellipticity by creating astigmatism in the beam (e.g., as described above).

Any convenient light source may be employed in the methods described herein. In embodiments, the light source may be any convenient laser, such as a continuous wave laser. For example, the laser may be a diode laser, such as an ultraviolet diode laser, a visible diode laser and a near-infrared diode laser. In other embodiments, the laser may be a helium-neon (HeNe) laser. In some instances, the laser is a gas laser, such as a helium-neon laser, argon laser, krypton laser, xenon laser, nitrogen laser, CO₂ laser, CO laser, argon-fluorine (ArF) excimer laser, krypton-fluorine (KrF) excimer laser, xenon chlorine (XeCl) excimer laser or xenon-fluorine (XeF) excimer laser or a combination thereof. In other instances, the subject flow cytometers include a dye laser, such as a stilbene, coumarin or rhodamine laser. In yet other instances, lasers of interest include a metal-vapor laser, such as a helium-cadmium (HeCd) laser, helium-mercury (HeHg) laser, helium-selenium (HeSe) laser, helium-silver (HeAg) laser, strontium laser, neon-copper (NeCu) laser, copper laser or gold laser and combinations thereof. In still other instances, the subject flow cytometers include a solid-state laser, such as a ruby laser, an Nd:YAG laser, NdCrYAG laser, Er:YAG laser, Nd:YLF laser, Nd:YVO₄ laser, Nd:YCa₄O(BO₃)₃ laser, Nd:YCOB laser, titanium sapphire laser, thulim YAG laser, ytterbium YAG laser, ytterbium₂O₃ laser or cerium doped lasers and combinations thereof.

In embodiments, the laser is a semiconductor laser diode, i.e., a laser that includes semiconductor gain media (i.e., the media for laser light amplification). In some embodiments, semiconductor laser diodes are pumped with an electrical current in the region between two semiconductor materials (i.e. “n-doped” and “p-doped” materials). In embodiments, the semiconductor laser diode is an optically pumped semiconductor laser in which light is used to excite a relevant medium to a higher energy state. In other embodiments, the laser is a quantum cascade laser, e.g., a quantum cascade laser that emits near-infrared light. In still other embodiments, the laser is an edge-emitting laser diode. In still other embodiments, the laser is an external cavity diode laser, e.g., including an anti-reflection coating and/or a collimating lens. In yet other embodiments, laser is a surface emitting semiconductor laser (VCSEL/VECSEL). In some instances, the laser is a continuous diode laser, such as an ultraviolet diode laser, a visible diode laser and a near-infrared diode laser. For example, the diode laser may be a 405 nm diode laser or a 488 nm diode laser. In some instances, the laser is a frequency doubled- or frequency tripled implementation of any of the above mentioned lasers. In some embodiments, components of the semiconductor laser diode may include materials such as, but not limited to, gallium arsenide (GaAs), aluminum gallium arsenide (AlGaAs), indium gallium phosphide (InGaP), gallium nitride (GaN), indium gallium arsenide (InGaAs), indium gallium arsenide nitride (GaInNAs), indium phosphide (InP), and gallium indium phosphide (GaInP), or combinations thereof. In some instances where the light source includes a laser diode, the performance of that laser diode may have been evaluated by the method described in U.S. Provisional Application No. 63/074,969, the disclosure of which is herein incorporated by reference.

Laser light sources according to certain embodiments may also include one or more optical adjustment components. The term “optical adjustment” is used herein in its conventional sense to refer to any device that is capable of changing the spatial width of irradiation or some other characteristic of irradiation from the light source, such as for example, irradiation direction, wavelength, beam width, beam intensity and focal spot.

Where the optical adjustment component is configured to move, the optical adjustment component may be configured to be moved continuously or in discrete intervals, such as for example in 0.01μ or greater increments, such as 0.05μ or greater, such as 0.1μ or greater, such as 0.5μ or greater such as 1μ or greater, such as 10μ, or greater, such as 100μ or greater, such as 500μ or greater, such as 1 mm or greater, such as 5 mm or greater, such as 10 mm or greater and including 25 mm or greater increments. Any displacement protocol may be employed to move the optical adjustment component structures, such as coupled to a moveable support stage or directly with a motor actuated translation stage, leadscrew translation assembly, geared translation device, such as those employing a stepper motor, servo motor, brushless electric motor, brushed DC motor, micro-step drive motor, high resolution stepper motor, among other types of motors.

In certain instances, the instant light source is configured to produce a flat-top beam. By “flat-top” beam it is meant a beam characterized by an intensity profile that is flat, as opposed to a Gaussian beam in which light intensity gradually increases to a peak and then subsequently decreases. In embodiments where a flat-top beam is produced, the area of the flow cell may be irradiated with a constant intensity of light. In some embodiments, production of a flat-top beam involves the use of one or more beam homogenizers configured to transform the beam such that it exhibits a flat-top profile. In other embodiments, production of a flat-top beam involves the use of a square core fiber configured to produce a square/uniform beam output. In further embodiments, the light source is configured to produce a collimated beam, i.e., a beam including parallel rays of light that spread minimally during propagation. In such embodiments, the light source may include one or more beam collimators.

In additional embodiments, the subject light sources include multiple lasers, e.g., so that the particles in the flow cell are irradiated with multiple different wavelengths of light. Any convenient number of lasers may be included. In some embodiments, light sources of interest include 1 or more lasers configured to provide laser light for irradiation of the flow stream, such as 2 lasers or more configured to provide laser light for irradiation of the flow stream, such as 3 lasers or more, such as 4 lasers or more, such as 5 lasers or more, such as 10 lasers or more, such as 15 lasers or more, such as 25 lasers or more and including 50 lasers or more configured to provide laser light for irradiation of the flow stream. Where more than one laser is employed, the sample may be irradiated with the lasers simultaneously or sequentially, or a combination thereof. For example, the sample may be simultaneously irradiated with each of the lasers. In other embodiments, the flow stream is sequentially irradiated with each of the lasers. Where more than one light source is employed to irradiate the sample sequentially, the time each light source irradiates the sample may independently be 0.001 microseconds or more, such as 0.01 microseconds or more, such as 0.1 microseconds or more, such as 1 microsecond or more, such as 5 microseconds or more, such as 10 microseconds or more, such as 30 microseconds or more and including 60 microseconds or more. For example, methods may include irradiating the sample with the light source (e.g. laser) for a duration which ranges from 0.001 microseconds to 100 microseconds, such as from 0.01 microseconds to 75 microseconds, such as from 0.1 microseconds to 50 microseconds, such as from 1 microsecond to 25 microseconds and including from 5 microseconds to 10 microseconds. In embodiments where sample is sequentially irradiated with two or more light sources, the duration sample is irradiated by each light source may be the same or different.

The time period between irradiation by each laser may also vary, as desired, being separated independently by a delay of 0.001 microseconds or more, such as 0.01 microseconds or more, such as 0.1 microseconds or more, such as 1 microsecond or more, such as 5 microseconds or more, such as by 10 microseconds or more, such as by 15 microseconds or more, such as by 30 microseconds or more and including by 60 microseconds or more. For example, the time period between irradiation by each laser may range from 0.001 microseconds to 60 microseconds, such as from 0.01 microseconds to 50 microseconds, such as from 0.1 microseconds to 35 microseconds, such as from 1 microsecond to 25 microseconds and including from 5 microseconds to 10 microseconds. In certain embodiments, the time period between irradiation by each laser is 10 microseconds. In embodiments where sample is sequentially irradiated by more than two (i.e., 3 or more) lasers, the delay between irradiation by each laser may be the same or different.

In some instances, the light source is a light source described in U.S. Provisional Application No. 63/076,650, the disclosure of which is herein incorporated by reference. In such instances, the subject light source includes a light propagator for conveying laser light from each laser to the flow stream. In some embodiments, the light propagation component includes a fiber optic operably coupled to each laser to convey laser light from each laser to a different position on the flow stream. Depending on the number of lasers in the light source, the light propagation component may include 2 or more fiber optics, such as 3 or more fiber optics, such as 4 or more fiber optics, such as 5 or more fiber optics, such as 6 or more fiber optics, such as 7 or more fiber optics, such as 8 or more fiber optics, such as 9 or more fiber optics, such as 10 or more fiber optics, such as 25 or more fiber optics, such as 50 or more fiber optics and including 100 or more fiber optics. In certain embodiments, the light propagation component includes one or more fiber optic bundles, such as 2 or more fiber optic bundles, such as 3 or more fiber optic bundles, such as 4 or more fiber optic bundles and including 5 or more fiber optic bundles. In some embodiments, each laser is operably coupled to a single fiber optic. In other embodiments, each laser is operably coupled to more than one fiber optic, such as where each laser is operably coupled to 2 or more fiber optics, such as 3 or more fiber optics, such as 4 or more fiber optics, such as 5 or more fiber optics, such as 6 or more fiber optics, such as 7 or more fiber optics, such as 8 or more fiber optics, such as 9 or more fiber optics, such as 10 or more fiber optics, such as 25 or more fiber optics, such as 50 or more fiber optics and including 100 or more fiber optics. For example, the ratio of laser to fiber optics in the light propagation component may be 1:2 or more, such as 1:3 or more, such as 1:4 or more, such as 1:5 or more, such as 1:6 or more, such as 1:7 or more, such as 1:8 or more, such as 1:9 or more, such as 1:10 or more, such as 1:25 or more, such as 1:50 or more and including a ratio of laser to fiber optics of 1:100 or more.

Each fiber optic operably coupled to the lasers may be a single mode fiber optic or a multimode fiber optic. In some embodiments, each laser is operably coupled to a single mode fiber optic. In other embodiments, each laser is operably coupled to a multi-mode fiber optic. In yet other embodiments, one or more lasers are operably coupled to a single mode fiber optic and one or more lasers are operably coupled to a multi-mode fiber optic. In certain embodiments, each laser is operably coupled to two or more fiber optics. In one example, each laser is operably coupled to two or more single mode fiber optics. In another example, each laser is operably coupled to two or more multi-mode fiber optic. In still another example, each laser is operably coupled to one or more single mode fiber optic and one or more multi-mode fiber optic.

In some embodiments, the light propagation component includes one or more fiber optic bundles. Where the light propagation component includes one or more fiber optic bundles, the lasers may be operably coupled to a single mode fiber optic bundle or a multi-mode fiber optic bundle. In some instances, each laser is operably coupled to a single mode fiber optic bundle. In other instances, each laser is operably coupled to a multi-mode fiber optic bundle. In yet other instances, one or more lasers are operably coupled to a single mode fiber optic bundle and one or more lasers are operably coupled to a multi-mode fiber optic bundle.

Depending on the position and pattern of irradiation of the flow stream by the laser light, the arrangement at the distal end of the fiber optics in the light propagation component may vary. In some embodiments, the fiber optics may be arranged at the distal end of the light propagation component in a cross-sectional shape such as a rectilinear cross sectional shape, e.g., squares, rectangles, trapezoids, triangles, hexagons, etc., curvilinear cross-sectional shapes, e.g., circles, ovals, as well as irregular shapes, e.g., a parabolic bottom portion coupled to a planar top portion. In certain embodiments, the distal end of the fiber optics of the light propagation component is arranged in a line pattern. In some instances, the distal end of the fiber optics of the light propagation component are arranged in a line pattern that is parallel to the longitudinal axis of the flow stream (i.e., parallel to the direction of sample flow).

In embodiments, the light propagation component is configured to convey light to different positions on a flow stream. For example, the light propagation component may be configured to convey light onto the flow stream based on arrangement of the distal end of the fiber optics. In some embodiments, the light propagation component is configured to convey laser light onto a flow stream in a predetermined pattern, such as a pattern having a rectilinear cross sectional shape, e.g., squares, rectangles, trapezoids, triangles, hexagons, etc., curvilinear cross-sectional shapes, e.g., circles, ovals, as well as irregular shapes, e.g., a parabolic bottom portion coupled to a planar top portion. In certain embodiments, the light propagation component is configured to convey light onto the flow stream in a linear pattern. In some instances, the light propagation component is configured to convey light onto the flow stream in a linear pattern that is parallel to the longitudinal axis of the flow stream (i.e., parallel to the direction of sample flow). In other instances, the light propagation component is configured to convey light onto the flow stream in a linear pattern that is orthogonal to the longitudinal axis of the flow stream (i.e., across a horizontal axis of the flow stream). The distance between the positions of irradiation on the flow stream by light conveyed by each fiber optic (e.g., when arranged in a line pattern) may be 0.0001 mm or more, such as 0.0005 mm or more, such as 0.001 mm or more, such as 0.005 mm or more, such as 0.01 mm or more, such as 0.05 mm or more, such as 0.1 mm or more, such as 0.2 mm or more, such as 0.3 mm or more, such as 0.5 mm or more, such as 0.6 mm or more, such as 0.7 mm or more, such as 0.8 mm or more, such as 0.9 mm or more, such as 1.0 mm or more, such as 2 mm or more and including 3 mm or more. In some embodiments, the distance between the position of irradiation on the flow stream by light conveyed by each fiber optic ranges from 0.0001 mm to 5 mm, such as from 0.0005 mm to 4.5 mm, such as from 0.001 mm to 4.0 mm, such as from 0.005 mm to 3.5 mm, such as from 0.01 mm to 3.0 mm, such as from 0.05 mm to 2.5 mm, such as from 0.1 mm to 2.0 mm and including from 0.2 mm to 1.5 mm.

In some embodiments, the light propagation component is configured to convey light from a first fiber optic to a first position on the flow stream and to convey light from a second fiber optic to a second position on the flow stream. In some instances, the second position is downstream from the first position on the flow stream. For example, the second position may be 0.0001 mm or more downstream from the first position on the flow stream, such as 0.0005 mm or more, such as 0.001 mm or more, such as 0.005 mm or more, such as 0.01 mm or more, such as 0.05 mm or more, such as 0.1 mm or more, such as 0.2 mm or more, such as 0.3 mm or more, such as 0.5 mm or more, such as 0.6 mm or more, such as 0.7 mm or more, such as 0.8 mm or more, such as 0.9 mm or more, such as 1.0 mm or more, such as 2 mm or more and including 3 mm or more downstream from the first position on the flow stream. In some instances, the second position is downstream from the first position on the flow stream by a distance that ranges from 0.0001 mm to 5 mm, such as from 0.0005 mm to 4.5 mm, such as from 0.001 mm to 4.0 mm, such as from 0.005 mm to 3.5 mm, such as from 0.01 mm to 3.0 mm, such as from 0.05 mm to 2.5 mm, such as from 0.1 mm to 2.0 mm and including from 0.2 mm to 1.5 mm. In certain embodiments, the second position is 0.2 mm or more downstream from the first position on the flow stream.

Aspects of the present invention include collecting fluorescent light with a fluorescent light detector. A fluorescent light detector may, in some instances, be configured to detect fluorescence emissions from fluorescent molecules, e.g., labeled specific binding members (such as labeled antibodies that specifically bind to markers of interest) associated with the particle in the flow cell. In certain embodiments, methods include detecting fluorescence from the sample with one or more fluorescent light detectors, such as 2 or more, such as 3 or more, such as 4 or more, such as 5 or more, such as 6 or more, such as 7 or more, such as 8 or more, such as 9 or more, such as 10 or more, such as 15 or more and including 25 or more fluorescent light detectors. In embodiments, each of the fluorescent light detectors is configured to generate a fluorescence data signal. Fluorescence from the sample may be detected by each fluorescent light detector, independently, over one or more of the wavelength ranges of 200 nm-1200 nm. In some instances, methods include detecting fluorescence from the sample over a range of wavelengths, such as from 200 nm to 1200 nm, such as from 300 nm to 1100 nm, such as from 400 nm to 1000 nm, such as from 500 nm to 900 nm and including from 600 nm to 800 nm. In other instances, methods include detecting fluorescence with each fluorescence detector at one or more specific wavelengths. For example, the fluorescence may be detected at one or more of 450 nm, 518 nm, 519 nm, 561 nm, 578 nm, 605 nm, 607 nm, 625 nm, 650 nm, 660 nm, 667 nm, 670 nm, 668 nm, 695 nm, 710 nm, 723 nm, 780 nm, 785 nm, 647 nm, 617 nm and any combinations thereof, depending on the number of different fluorescent light detectors in the subject light detection system. In certain embodiments, methods include detecting wavelengths of light which correspond to the fluorescence peak wavelength of certain fluorochromes present in the sample. In embodiments, fluorescent flow cytometer data is received from one or more fluorescent light detectors (e.g., one or more detection channels), such as 2 or more, such as 3 or more, such as 4 or more, such as 5 or more, such as 6 or more and including 8 or more fluorescent light detectors (e.g., 8 or more detection channels).

### Computer-Controlled Systems

Aspects of the present disclosure further include computer-controlled systems, where the systems further include one or more computers for complete automation or partial automation. In some embodiments, systems include a computer having a computer readable storage medium with a computer program stored thereon, where the computer program when loaded on the computer includes instructions for receiving and analyzing flow cytometer data that has been collected from the irradiation of particles in a flow cytometer that includes a tilted beam shaping optical component.

In embodiments, the system includes an input module, a processing module and an output module. The subject systems may include both hardware and software components, where the hardware components may take the form of one or more platforms, e.g., in the form of servers, such that the functional elements, i.e., those elements of the system that carry out specific tasks (such as managing input and output of information, processing information, etc.) of the system may be carried out by the execution of software applications on and across the one or more computer platforms represented of the system.

Systems may include a display and operator input device. Operator input devices may, for example, be a keyboard, mouse, or the like. The processing module includes a processor which has access to a memory having instructions stored thereon for performing the steps of the subject methods. The processing module may include an operating system, a graphical user interface (GUI) controller, a system memory, memory storage devices, and input-output controllers, cache memory, a data backup unit, and many other devices. The processor may be a commercially available processor, or it may be one of other processors that are or will become available. The processor executes the operating system and the operating system interfaces with firmware and hardware in a well-known manner, and facilitates the processor in coordinating and executing the functions of various computer programs that may be written in a variety of programming languages, such as Java, Perl, C++, other high level or low level languages, as well as combinations thereof, as is known in the art. The operating system, typically in cooperation with the processor, coordinates and executes functions of the other components of the computer. The operating system also provides scheduling, input-output control, file and data management, memory management, and communication control and related services, all in accordance with known techniques. The processor may be any suitable analog or digital system. In some embodiments, processors include analog electronics which allows the user to manually align a light source with the flow stream based on the first and second light signals. In some embodiments, the processor includes analog electronics which provide feedback control, such as for example negative feedback control.

The system memory may be any of a variety of known or future memory storage devices. Examples include any commonly available random access memory (RAM), magnetic medium such as a resident hard disk or tape, an optical medium such as a read and write compact disc, flash memory devices, or other memory storage device. The memory storage device may be any of a variety of known or future devices, including a compact disk drive, a tape drive, a removable hard disk drive, or a diskette drive. Such types of memory storage devices typically read from, and/or write to, a program storage medium (not shown) such as, respectively, a compact disk, magnetic tape, removable hard disk, or floppy diskette. Any of these program storage media, or others now in use or that may later be developed, may be considered a computer program product. As will be appreciated, these program storage media typically store a computer software program and/or data. Computer software programs, also called computer control logic, typically are stored in system memory and/or the program storage device used in conjunction with the memory storage device.

In some embodiments, a computer program product is described comprising a computer usable medium having control logic (computer software program, including program code) stored therein. The control logic, when executed by the processor the computer, causes the processor to perform functions described herein. In other embodiments, some functions are implemented primarily in hardware using, for example, a hardware state machine. Implementation of the hardware state machine so as to perform the functions described herein will be apparent to those skilled in the relevant arts.

Memory may be any suitable device in which the processor can store and retrieve data, such as magnetic, optical, or solid-state storage devices (including magnetic or optical disks or tape or RAM, or any other suitable device, either fixed or portable). The processor may include a general-purpose digital microprocessor suitably programmed from a computer readable medium carrying necessary program code. Programming can be provided remotely to processor through a communication channel, or previously saved in a computer program product such as memory or some other portable or fixed computer readable storage medium using any of those devices in connection with memory. For example, a magnetic or optical disk may carry the programming, and can be read by a disk writer/reader. Systems of the invention also include programming, e.g., in the form of computer program products, algorithms for use in practicing the methods as described above. Programming according to the present invention can be recorded on computer readable media, e.g., any medium that can be read and accessed directly by a computer. Such media include, but are not limited to: magnetic storage media, such as floppy discs, hard disc storage medium, and magnetic tape; optical storage media such as CD-ROM; electrical storage media such as RAM and ROM; portable flash drive; and hybrids of these categories such as magnetic/optical storage media.

The processor may also have access to a communication channel to communicate with a user at a remote location. By remote location is meant the user is not directly in contact with the system and relays input information to an input manager from an external device, such as a computer connected to a Wide Area Network (“WAN”), telephone network, satellite network, or any other suitable communication channel, including a mobile telephone (i.e., smartphone).

In some embodiments, systems according to the present disclosure may be configured to include a communication interface. In some embodiments, the communication interface includes a receiver and/or transmitter for communicating with a network and/or another device. The communication interface can be configured for wired or wireless communication, including, but not limited to, radio frequency (RF) communication (e.g., Radio-Frequency Identification (RFID), Zigbee communication protocols, WiFi, infrared, wireless Universal Serial Bus (USB), Ultra Wide Band (UWB), Bluetooth® communication protocols, and cellular communication, such as code division multiple access (CDMA) or Global System for Mobile communications (GSM).

In one embodiment, the communication interface is configured to include one or more communication ports, e.g., physical ports or interfaces such as a USB port, an RS-232 port, or any other suitable electrical connection port to allow data communication between the subject systems and other external devices such as a computer terminal (for example, at a physician's office or in hospital environment) that is configured for similar complementary data communication.

In one embodiment, the communication interface is configured for infrared communication, Bluetooth® communication, or any other suitable wireless communication protocol to enable the subject systems to communicate with other devices such as computer terminals and/or networks, communication enabled mobile telephones, personal digital assistants, or any other communication devices which the user may use in conjunction.

In one embodiment, the communication interface is configured to provide a connection for data transfer utilizing Internet Protocol (IP) through a cell phone network, Short Message Service (SMS), wireless connection to a personal computer (PC) on a Local Area Network (LAN) which is connected to the internet, or WiFi connection to the internet at a WiFi hotspot.

In one embodiment, the subject systems are configured to wirelessly communicate with a server device via the communication interface, e.g., using a common standard such as 802.11 or Bluetooth® RF protocol, or an IrDA infrared protocol. The server device may be another portable device, such as a smart phone, Personal Digital Assistant (PDA) or notebook computer; or a larger device such as a desktop computer, appliance, etc. In some embodiments, the server device has a display, such as a liquid crystal display (LCD), as well as an input device, such as buttons, a keyboard, mouse or touch-screen.

In some embodiments, the communication interface is configured to automatically or semi-automatically communicate data stored in the subject systems, e.g., in an optional data storage unit, with a network or server device using one or more of the communication protocols and/or mechanisms described above.

Output controllers may include controllers for any of a variety of known display devices for presenting information to a user, whether a human or a machine, whether local or remote. If one of the display devices provides visual information, this information typically may be logically and/or physically organized as an array of picture elements. A graphical user interface (GUI) controller may include any of a variety of known or future software programs for providing graphical input and output interfaces between the system and a user, and for processing user inputs. The functional elements of the computer may communicate with each other via system bus. Some of these communications may be accomplished in alternative embodiments using network or other types of remote communications. The output manager may also provide information generated by the processing module to a user at a remote location, e.g., over the Internet, phone or satellite network, in accordance with known techniques. The presentation of data by the output manager may be implemented in accordance with a variety of known techniques. As some examples, data may include SQL, HTML or XML documents, email or other files, or data in other forms. The data may include Internet URL addresses so that a user may retrieve additional SQL, HTML, XML, or other documents or data from remote sources. The one or more platforms present in the subject systems may be any type of known computer platform or a type to be developed in the future, although they typically will be of a class of computer commonly referred to as servers. However, they may also be a main-frame computer, a workstation, or other computer type. They may be connected via any known or future type of cabling or other communication system including wireless systems, either networked or otherwise. They may be co-located or they may be physically separated. Various operating systems may be employed on any of the computer platforms, possibly depending on the type and/or make of computer platform chosen. Appropriate operating systems include Windows NT, Windows XP, Windows 7, Windows 8, iOS, Sun Solaris, Linux, OS/400, Compaq Tru64 Unix, SGI IRIX, Siemens Reliant Unix, and others.

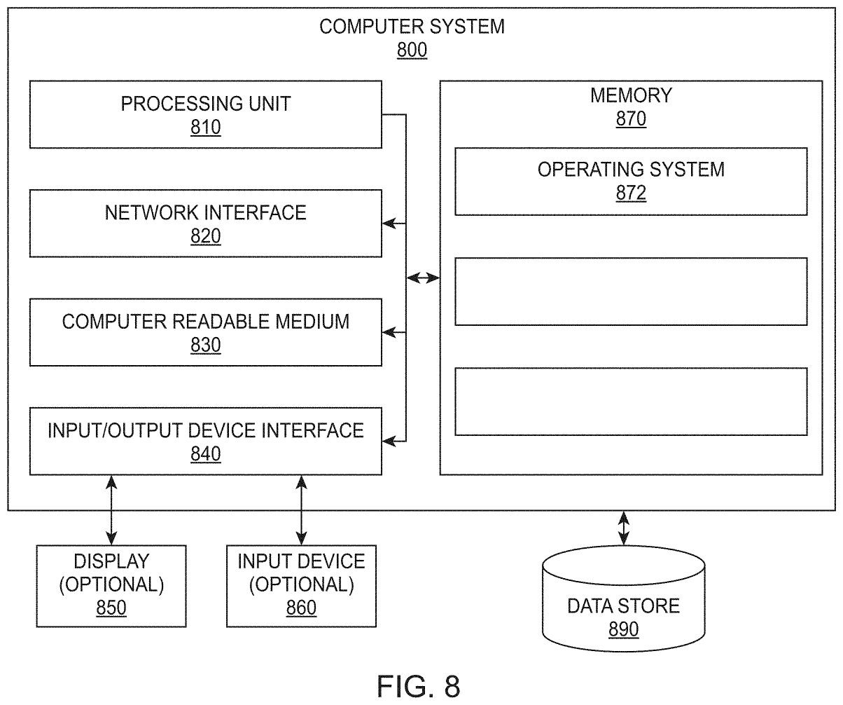

FIG. 8 depicts a general architecture of an example computing device 800 according to certain embodiments. The general architecture of the computing device 800 depicted in FIG. 8 includes an arrangement of computer hardware and software components. It is not necessary, however, that all of these generally conventional elements be shown in order to provide an enabling disclosure. As illustrated, the computing device 800 includes a processing unit 810, a network interface 820, a computer readable medium drive 830, an input/output device interface 840, a display 850, and an input device 860, all of which may communicate with one another by way of a communication bus. The network interface 820 may provide connectivity to one or more networks or computing systems. The processing unit 810 may thus receive information and instructions from other computing systems or services via a network. The processing unit 810 may also communicate to and from memory 870 and further provide output information for an optional display 850 via the input/output device interface 840. For example, an analysis software (e.g., data analysis software or program such as FlowJo®) stored as executable instructions in the non-transitory memory of the analysis system can display the flow cytometry event data to a user. The input/output device interface 840 may also accept input from the optional input device 860, such as a keyboard, mouse, digital pen, microphone, touch screen, gesture recognition system, voice recognition system, gamepad, accelerometer, gyroscope, or other input device.

The memory 870 may contain computer program instructions (grouped as modules or components in some embodiments) that the processing unit 810 executes in order to implement one or more embodiments. The memory 870 generally includes RAM, ROM and/or other persistent, auxiliary or non-transitory computer-readable media. The memory 870 may store an operating system 872 that provides computer program instructions for use by the processing unit 810 in the general administration and operation of the computing device 800. Data may be stored in data storage device 890. The memory 870 may further include computer program instructions and other information for implementing aspects of the present disclosure.

### Utility

The subject flow cytometers and methods find use in a variety of applications where it is desirable to increase resolution and accuracy in the determination of parameters for analytes (e.g., cells, particles) in a biological sample. The subject flow cytometers and methods particularly find use in generating beam ellipticity in a flow cytometer setting, especially a flow cytometer setting in which it is desirable to generate uniform laser intensity across the core flow. Generating beam ellipticity has the effect of ensuring optimal irradiation of particles passing through the flow cell. The subject flow cytometers and methods further find use where it is desirable to streamline the flow cytometry process, i.e., by reducing the number of optical components required to perform flow cytometry and generate an elliptical beam shape. In some embodiments of the invention, additional optics positioned between the light source and the flow cell (i.e., prism pair, cylindrical lens) are not required to supplement the beam shaping activity of the tilted beam shaping optical component.

The present disclosure can be employed to characterize many types of analytes, in particular, analytes relevant to medical diagnosis or protocols for caring for a patient, including but not limited to: proteins (including both free proteins and proteins and proteins bound to the surface of a structure, such as a cell), nucleic acids, viral particles, and the like. Further, samples can be from in vitro or in vivo sources, and samples can be diagnostic samples.

### KITS

Aspects of the present disclosure further include kits, where kits include one or more tilted beam shaping optical components (e.g., lenses and/or concave mirrors), and instructions for installing the tilted beam shaping optical component(s) in a flow cytometer. For example, the subject kits may include instructions for removing existing optical components for producing beam ellipticity (e.g., prism pairs, cylindrical lenses), and replacing said additional optical components with a tilted beam shaping optical component. In embodiments, kits further include instructions for adjusting the tilted beam shaping optical component to achieve desired effects regarding beam shape, aspect ratio, and focus location. In some instances, the instructions enable a user to adjust the tilt of the tilted beam shaping optical component such that, e.g., the major axis of the resulting beam may be altered as desired. In additional instances, the instructions enable a user to adjust the position of the tilted beam shaping optical component relative to the flow cell and the light source to toggle the magnification ratio of the imaging system. The instructions described herein may be included on storage media such as a floppy disk, hard disk, optical disk, magneto-optical disk, CD-ROM, CD-R magnetic tape, non-volatile memory card, ROM, DVD-ROM, Blue-ray disk, solid state disk, and network attached storage (NAS). Any of these program storage media, or others now in use or that may later be developed, may be included in the subject kits. These instructions may be present in the subject kits in a variety of forms, one or more of which may be present in the kit. One form in which these instructions may be present is as printed information on a suitable medium or substrate, e.g., a piece or pieces of paper on which the information is printed, in the packaging of the kit, in a package insert, and the like. Yet another form of these instructions is a computer readable medium, e.g., diskette, compact disk (CD), portable flash drive, and the like, on which the information has been recorded. Yet another form of these instructions that may be present is a website address which may be used via the internet to access the information at a removed site.

The following is offered by way of illustration and not by way of limitation.

### EXPERIMENTAL

### Experiment Design 1

An experimental optical system that includes a tilted beam shaping optical component was planned according to the schematic diagram shown in FIG. 3. The optical system included a fiber optic light conveyor characterized by a λ of 0.64 μm and diameter of 6.8 μm, or a λ of 0.488 μm and diameter of 4.5 μm, or a λ of 0.405 μm and diameter of 3.7 μm. The optical system further included a tilted beam shaping optical component in the form of a concave mirror characterized by a radius of curvature of 100 mm, a tilt angle of 5.5 degrees and separation distance from the fiber optic light conveyor of 90 mm.

When a beam is emitted by the fiber optic light conveyor and reflected by the mirror, two beam foci are generated: a first focus located a distance of 110.83 mm from the tilted beam shaping optical component, and a second focus located at a distance of 113.14 mm from the tilted beam shaping optical component.

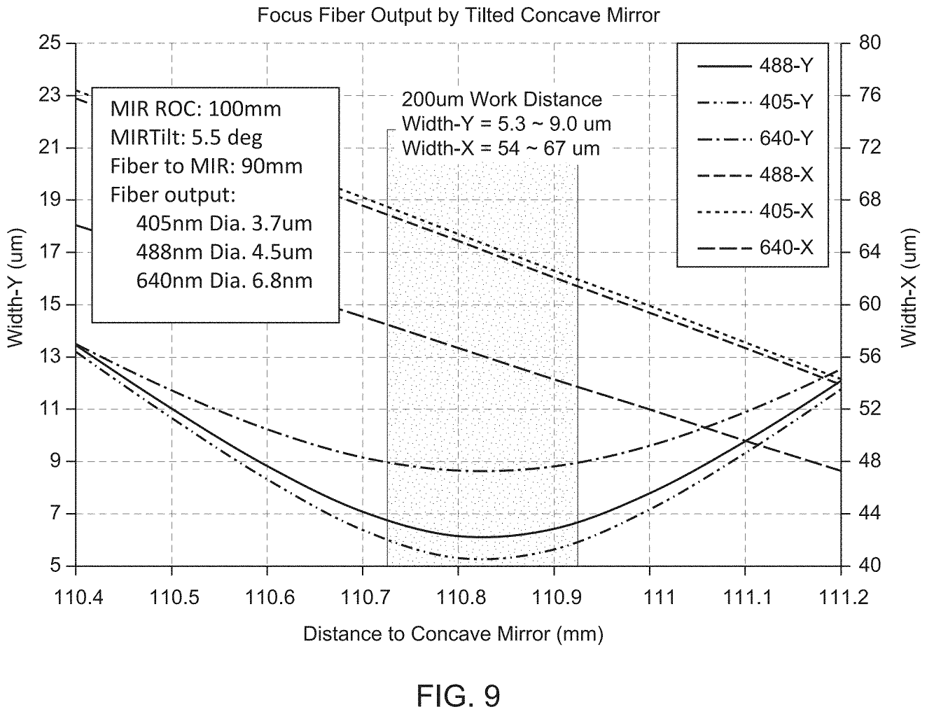

The size of the beam at different locations along the optical path of the light is then simulated and depicted in FIG. 9. As shown in FIG. 9, the positions of the foci are not dependent on wavelength. Beam sizes located within the shaded area of the graph were determined to be suitable for use in flow cytometry. In addition, results indicated that beam width could be tuned by adjusting the position of the mirror, and that the width of the beam in the x direction and the width of the beam in the y direction could be tuned by adjusting the mirror tilt angle.

### Experiment 1

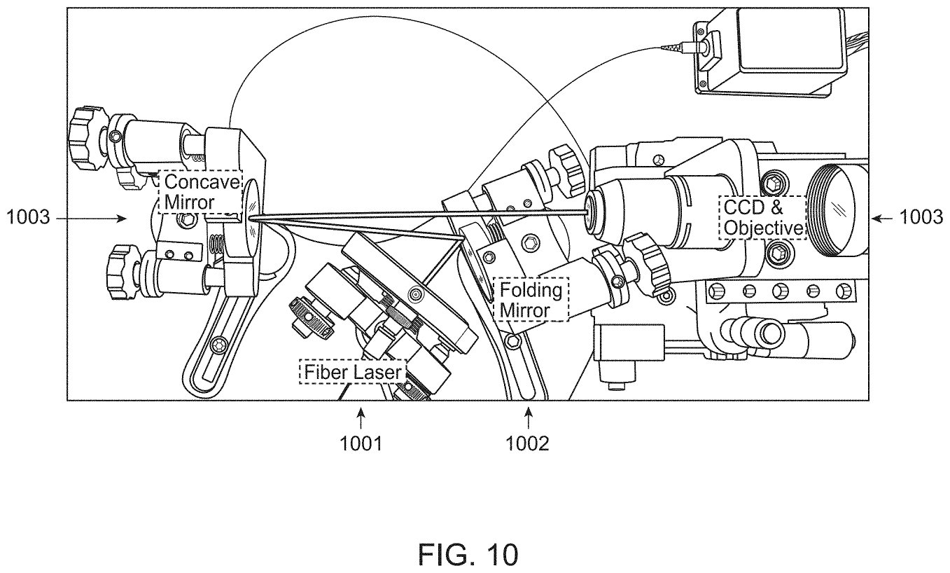

The experimental optical system shown in FIG. 10 was created, and includes a FISBA laser 1001, a folding mirror 1002, a tilted beam shaping optical component in the form of concave mirror 1003, and CCD detector 1003. The FISBA laser was configured to emit beams of light characterized by three different colors at 405 nm, 488 nm and 640 nm. Each color was emitted by the laser one at a time, and laser profile data was obtained using the CCD detector for that color.

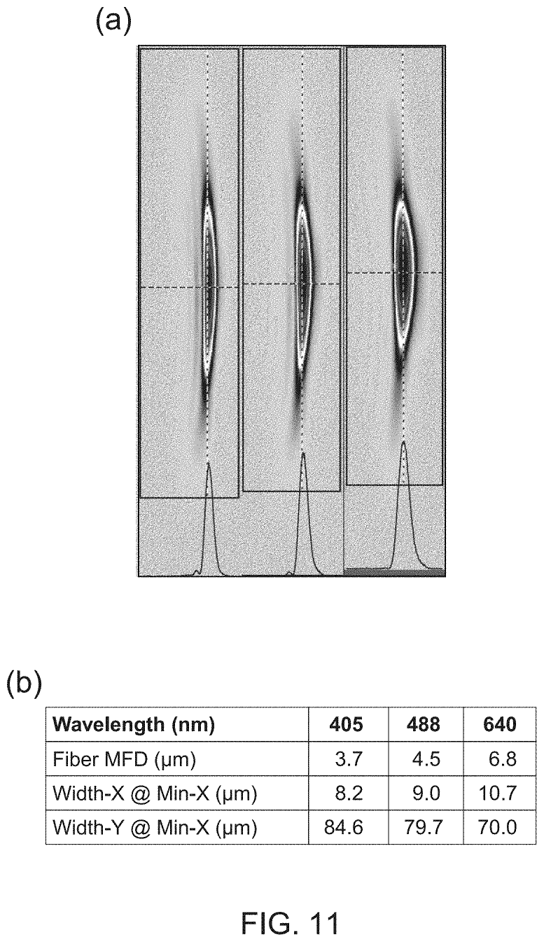

FIG. 11 displays the results collected by the CCD detector 1003 shown in FIG. 10. FIG. 11A depicts beam intensity profiles at first foci for each of the different wavelengths emitted by the laser (from left to right: 405 nm, 488 nm and 640 nm). As shown in FIG. 11A, each of the beams reflected by the tilted beam shaping optical component exhibits an elliptical beam shape. FIG. 11B presents a table that includes parameters regarding beam shape for each of the three different beams. As shown in FIG. 11B, beam width in they (i.e., vertical) direction is significantly larger than beam width in the x (i.e., horizontal) direction.

### Experiment 2

An experimental optical system that includes a tilted beam shaping optical component was created according to the schematic diagram shown in FIG. 5. The optical system employed an optical fiber bundle in which fiber optics were spaced 0.2 mm from each other and were characterized by a numerical aperture of 0.13. After light was emitted from the fiber bundle, it was reflected by a fold mirror that separated from the fiber bundle by a distance of 20 mm and set at an angle of incidence of 30 degrees. The fold mirror is added for the convenience of adjustment and to avoid the possible confliction between fiber source to the target. Light was reflected by the fold mirror to the tilted beam shaping optical component (i.e., concave mirror). The concave mirror was separated from the fold mirror by a distance of 70 mm and is set an angle of incidence of 6 degrees. Light reflected by the concave mirror subsequently encountered the target (i.e., beam focus) set at a distance of 111.12 mm from the concave mirror. Beam profile data was subsequently collected.

Following data collection, parameters of the experimental optical system were subsequently adjusted so that the distance separating the fiber bundle and the concave mirror was 85 mm, and the distance separating the target and the concave mirror was 119.80 mm. Beam profile data collection was then repeated under the adjusted parameters.

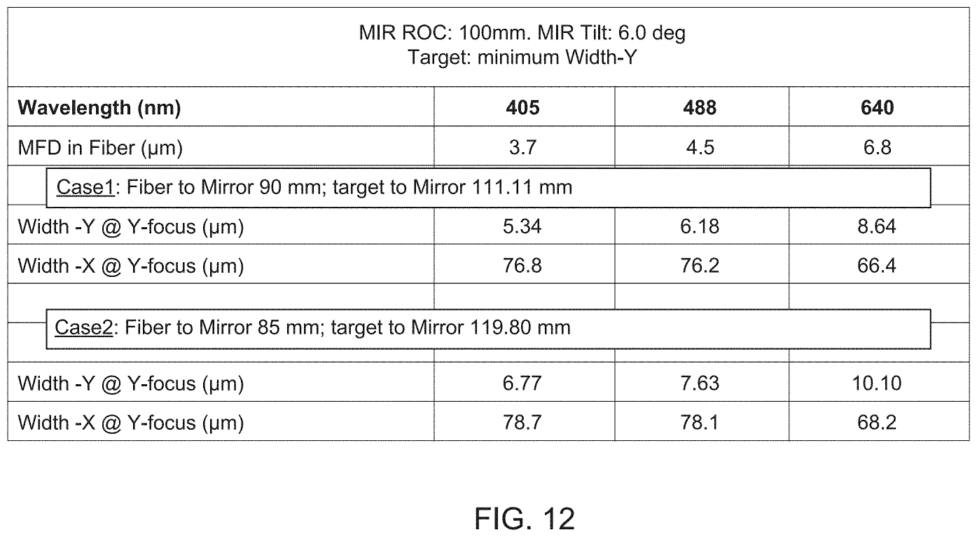

Beam profile data collected from the above-described optical system is presented in FIG. 12. Data were recorded for each set of measurement parameters described above. Data in Case 1 were collected under measurement parameters in which the distance separating the fiber optics bundle and concave mirror was 90 mm and the distance separating the target at the concave mirror was 111.11 mm, while data in Case 2 were collected under measurement parameters in which the distance separating the fiber optics bundle and concave mirror was 85 mm and the distance separating the target and the concave mirror was 119.80. As shown in FIG. 12, beam size measured at the target relates to the ratio of (Fiber-Concave Mirror Distance)/ROC. In addition, the asymmetry of the beam measured at the target is decided by the concave tilt angle.

Although the foregoing invention has been described in some detail by way of illustration and example for purposes of clarity of understanding, it is readily apparent to those of ordinary skill in the art in light of the teachings of this invention that some changes and modifications may be made thereto without departing from the spirit or scope of the appended claims.

Accordingly, the preceding merely illustrates the principles of the invention. It will be appreciated that those skilled in the art will be able to devise various arrangements which, although not explicitly described or shown herein, embody the principles of the invention and are included within its spirit and scope. Furthermore, all examples and conditional language recited herein are principally intended to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. Moreover, nothing disclosed herein is intended to be dedicated to the public regardless of whether such disclosure is explicitly recited in the claims.

The scope of the present invention, therefore, is not intended to be limited to the exemplary embodiments shown and described herein. Rather, the scope and spirit of present invention is embodied by the appended claims. In the claims, 35 U.S.C. § 112(f) or 35 U.S.C. § 112(6) is expressly defined as being invoked for a limitation in the claim only when the exact phrase “means for” or the exact phrase “step for” is recited at the beginning of such limitation in the claim; if such exact phrase is not used in a limitation in the claim, then 35 U.S.C. § 112 (f) or 35 U.S.C. § 112(6) is not invoked.

1. A flow cytometer comprising:
a flow cell;
a light source configured to produce a beam for irradiating particles in the flow cell at an interrogation point; and
a tilted beam shaping optical component positioned between the light source and the flow cell, wherein the tilted beam shaping optical is configured to generate ellipticity in the beam.

2. The flow cytometer according to claim 1, wherein the tilted beam shaping optical component is configured to produce beam ellipticity by creating astigmatism in the beam.

3. The flow cytometer according to claim 1, wherein the beam ellipticity generated by the tilted beam shaping optical component is characterized by an aspect ratio ranging from 3 to 20.

4. The flow cytometer according to claim 1, wherein the tilted beam shaping optical component comprises a lens.

5. The flow cytometer according to claim 1, wherein the tilted beam shaping optical component comprises a concave mirror.

6. The flow cytometer according to claim 4, wherein the tilt of the tilted beam shaping optical component ranges from 1 to 15 degrees.

7. The flow cytometer according to claim 6, wherein the tilt of the tilted beam shaping optical component ranges from 5 to 7 degrees.

8. The flow cytometer according to claim 6, wherein the tilt of the tilted beam shaping optical component is adjustable.

9-10. (canceled)

11. The flow cytometer according to claim 1, wherein the light source comprises:
a first fiber optic operably coupled to a first laser and configured to receive light from the first laser at a proximal end and to convey the laser light beam from a distal end to a first position on the flow stream; and
a second fiber optic operably coupled to a second laser and configured to receive light from the second laser at a proximal end and to convey the laser light beam from a distal end to a second position on the flow stream.

12. The flow cytometer according to claim 11, wherein the light source comprises three or more lasers.

13. The flow cytometer according to claim 11, wherein the light source comprises a fiber optic bundle.

14. The flow cytometer according to claim 13, wherein the tilted beam shaping optical component generates beam ellipticity in each of the two or more beams produced by the fiber optic bundle.

15. The flow cytometer according to claim 14, wherein the beam focus is achromatic.

16. The flow cytometer according to claim 1, wherein the light source is configured to produce a flat-top beam.

17. The flow cytometer according to claim 16, wherein the light source comprises a square core fiber.

18. The flow cytometer according to claim 1, wherein the light source is a collimated light source.

19. The flow cytometer according to claim 11, wherein the light source is configured to emit a circular beam.

20. The flow cytometer according to claim 1, further comprising a detector for collecting particle-modulated light from the flow cell.

21. A method of analyzing a sample, the method comprising:
(a) introducing the sample into a flow cytometer comprising:
a flow cell;
a light source configured to produce a beam for irradiating particles in the flow cell at an interrogation point; and
a tilted beam shaping optical component positioned between the light source and the flow cell, wherein the tilted beam shaping optical is configured to generate ellipticity in the beam; and
(b) detecting particle-modulated light emitted from the flow cell to analyze the sample.

22. The method according to claim 21, wherein the tilted beam shaping optical component is configured to produce beam ellipticity by creating astigmatism in the beam.

23-39. (canceled)
